(19) United States
(12) Patent Application Publication
(10) Pub. No.: US 2024/0195975 A1
(43) Pub. Date: Jun. 13, 2024

(54) CONTEXT MODELING FOR SIGN AND MAGNITUDE PREDICTION

(71) Applicant: Comcast Cable Communications, LLC, Philadelphia, PA (US)

(72) Inventors: Alexey Konstantinovich Filippov, Khimki (RU); Vasily Alexeevich Rufitskiy, Vladimir (RU); Esmael Hejazi Dinan, McLean, VA (US)

(21) Appl. No.: 18/534,391

(22) Filed: Dec. 8, 2023

Related U.S. Application Data
(60) Provisional application No. 63/431,623, filed on Dec. 9, 2022.

(51) Int. Cl. H04N 19/13; H04N 19/137; H04N 19/91

(52) U.S. Cl. CPC H04N 19/13; H04N 19/137; H04N 19/91

(57) ABSTRACT

A probability model may be selected based on an indication of whether a magnitude symbol of a block vector difference (BVD) matches a magnitude symbol of a BVD predictor. The determined probability model may be used to decode indications of whether other magnitude symbols of the BVD match other magnitude symbols of the BVD predictor. The magnitude of the BVD may be determined using the values of the magnitude symbols of the BVD predictor and the indications of whether the magnitude symbols of the BVD match the magnitude symbols of the BVD predictor.

### CROSS-REFERENCE TO RELATED APPLICATIONS

The application claims the benefit of U.S. Provisional Application No. 63/431,623 filed on Dec. 9, 2022. The above-referenced application is hereby incorporated by reference in its entirety.

### BACKGROUND

In bypass athematic coding mode a magnitude of a block vector difference (BVD) may be determined. The BVD may be used as part of advanced motion vector prediction for (AMVP) for inter prediction and intra block copy (IBC).

### SUMMARY

The following summary presents a simplified summary of certain features. The summary is not an extensive overview and is not intended to identify key or critical elements.

Bypass arithmetic coding may be used to increase the speed of an arithmetic coding process. A magnitude of a block vector difference (BVD) may be coded in a bypass arithmetic coding mode, but, because the probability distributions of the syntax elements are presumed to be uniformly distributed, BVD syntax elements may be limited. Entropy coding an indication of whether a magnitude symbol of a BVD prediction candidate matches the magnitude symbol of the BVD may be performed, for example, rather than entropy coding the magnitude symbol of the BVD. An improved compression efficiency may be achieved because the indication may have a non-uniform probability distribution. The BVD prediction candidate may be selected from a plurality of BVD prediction candidates, for example, based on costs of the BVD candidates that may be calculated based on a difference between a template of the current block and a template of the candidate reference block.

These and other features and advantages are described in greater detail below.

### BRIEF DESCRIPTION OF THE DRAWINGS

Examples of several of the various embodiments of the present disclosure are described herein with reference to the drawings.

FIG. 1 shows an example video coding/decoding system.

FIG. 2 shows an example encoder.

FIG. 3 shows an example decoder.

FIG. 4 shows an example quadtree partitioning of a coding tree block (CTB).

FIG. 5 shows an example quadtree corresponding to the example quadtree partitioning of the CTB in FIG. 4.

FIG. 6 shows example binary tree and ternary tree partitions.

FIG. 7 shows an example of combined quadtree and multi-type tree partitioning of a CTB.

FIG. 8 shows a tree corresponding to the combined quadtree and multi-type tree partitioning of the CTB shown in FIG. 7.

FIG. 9 shows an example set of reference samples determined for intra prediction of a current block.

FIGS. 10A and 10B show example intra prediction modes.

FIG. 11 shows a current block and corresponding reference samples.

FIG. 12 shows an example application of an intra prediction mode for prediction of a current block.

FIG. 13A shows an example of inter prediction.

FIG. 13B shows an example motion vector.

FIG. 14 shows an example of bi-prediction.

FIG. 15A shows example spatial candidate neighboring blocks for a current block.

FIG. 15B shows example temporal, co-located blocks for a current block.

FIG. 16 shows an example of intra block copy (IBC) for encoding.

FIG. 17 shows an example of a context-based adaptive binary arithmetic coding (CABAC) encoder.

FIG. 18A shows an example of intra block copy (IBC).

FIG. 18B shows example BVD candidates for entropy encoding a magnitude symbol of a BVD.

FIG. 18C shows an example table with components and costs of BVD candidates.

FIG. 18D shows an example of a decoder determining a magnitude signal of a BVD.

FIG. 19 shows a method for a context modeler to determine a probability model for an indication.

FIG. 20 shows an example method for a context modeler to determine a probability model for an indication.

FIGS. 21A-21D show examples of deriving a context model using 1^{st}-order Markov models.

FIGS. 22A and 22B show examples of deriving a context model using 2^{nd}-order Markov chains.

FIG. 23 shows an example of switching between context derivation techniques.

FIG. 24 shows an example method of selecting the most significant bins (MSB) of horizontal and vertical components of a vector difference.

FIG. 25 shows an example method of encoding an indication of whether a value of a magnitude symbol matches a value of a prediction of that magnitude symbol.

FIG. 26 shows an example method of determining a value of a magnitude symbol.

FIG. 27 shows an example computer system in which examples of the present disclosure may be implemented.

FIG. 28 shows example elements of a computing device that may be used to implement any of the various devices described herein.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of video encoding and decoding systems, which may be used in the technical field of video data storage and/or transmission/reception. More particularly, the technology disclosed herein may relate to video compression as used in encoding and/or decoding devices and/or systems.

A video sequence, comprising multiple pictures/frames, may be represented in digital form for storage and/or transmission. Representing a video sequence in digital form may require a large quantity of bits. Large data sizes that may be associated with video sequences may require significant resources for storage and/or transmission. Video encoding may be used to compress a size of a video sequence for more efficient storage and/or transmission. Video decoding may be used to decompress a compressed video sequence for display and/or other forms of consumption.

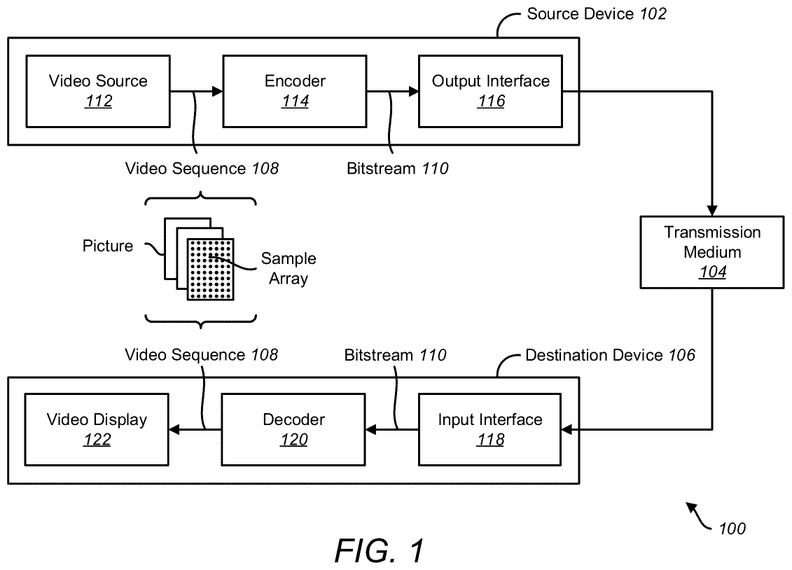

FIG. 1 shows an example video coding/decoding system. Video coding/decoding system 100 may comprise a source device 102, a transmission medium 104, and a destination device 106. The source device 102 may encode a video sequence 108 into a bitstream 110 for more efficient storage and/or transmission. The source device 102 may store and/or send/transmit the bitstream 110 to the destination device 106 via the transmission medium 104. The destination device 106 may decode the bitstream 110 to display the video sequence 108. The destination device 106 may receive the bitstream 110 from the source device 102 via the transmission medium 104. The source device 102 and/or the destination device 106 may be any of a plurality of different devices (e.g., a desktop computer, laptop computer, tablet computer, smart phone, wearable device, television, camera, video gaming console, set-top box, video streaming device, etc.).

The source device 102 may comprise (e.g., for encoding the video sequence 108 into the bitstream 110) one or more of a video source 112, an encoder 114, and/or an output interface 116. The video source 112 may provide and/or generate the video sequence 108 based on a capture of a natural scene and/or a synthetically generated scene. A synthetically generated scene may be a scene comprising computer generated graphics and/or screen content. The video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A video sequence, such as video sequence 108, may comprise a series of pictures (also referred to as frames). A video sequence may achieve an impression of motion based on successive presentation of pictures of the video sequence using a constant time interval or variable time intervals between the pictures. A picture may comprise one or more sample arrays of intensity values. The intensity values may be taken (e.g., measured, determined, provided) at a series of regularly spaced locations within a picture. A color picture may comprise (e.g., typically comprises) a luminance sample array and two chrominance sample arrays. The luminance sample array may comprise intensity values representing the brightness (e.g., luma component, Y) of a picture. The chrominance sample arrays may comprise intensity values that respectively represent the blue and red components of a picture (e.g., chroma components, Cb and Cr) separate from the brightness. Other color picture sample arrays may be possible based on different color schemes (e.g., a red, green, blue (RGB) color scheme). A pixel, in a color picture, may refer to/comprise/be associated with all intensity values (e.g., luma component, chroma components), for a given location, in the sample arrays used to represent color pictures. A monochrome picture may comprise a single, luminance sample array. A pixel, in a monochrome picture, may refer to/comprise/be associated with the intensity value (e.g., luma component) at a given location in the single, luminance sample array used to represent monochrome pictures.

The encoder 114 may encode the video sequence 108 into the bitstream 110. The encoder 114 may apply/use (e.g., to encode the video sequence 108) one or more prediction techniques to reduce redundant information in the video sequence 108. Redundant information may comprise information that may be predicted at a decoder and need not be transmitted to the decoder for accurate decoding of the video sequence 108. For example, the encoder 114 may apply spatial prediction (e.g., intra-frame or intra prediction), temporal prediction (e.g., inter-frame prediction or inter prediction), inter-layer prediction, and/or other prediction techniques to reduce redundant information in the video sequence 108. The encoder 114 may partition pictures comprising the video sequence 108 into rectangular regions referred to as blocks, for example, prior to applying one or more prediction techniques. The encoder 114 may then encode a block using the one or more of the prediction techniques.

The encoder 114 may search for a block similar to the block being encoded in another picture (e.g., a reference picture) of the video sequence 108, for example, for temporal prediction. The block determined during the search (e.g., a prediction block) may then be used to predict the block being encoded. The encoder 114 may form a prediction block based on data from reconstructed neighboring samples of the block to be encoded within the same picture of the video sequence 108, for example, for spatial prediction. A reconstructed sample may be a sample that was encoded and then decoded. The encoder 114 may determine a prediction error (e.g., a residual) based on the difference between a block being encoded and a prediction block. The prediction error may represent non-redundant information that may be sent/transmitted to a decoder for accurate decoding of the video sequence 108.

The encoder 114 may apply a transform to the prediction error (e.g. using a discrete cosine transform (DCT), or any other transform) to generate transform coefficients. The encoder 114 may form the bitstream 110 based on the transform coefficients and other information used to determine prediction blocks using/based on prediction types, motion vectors, and prediction modes. The encoder 114 may perform one or more of quantization and entropy coding of the transform coefficients and/or the other information used to determine the prediction blocks, for example, prior to forming the bitstream 110. The quantization and/or the entropy coding may further reduce the quantity of bits needed to store and/or transmit the video sequence 108.

The output interface 116 may be configured to write and/or store the bitstream 110 onto the transmission medium 104 for transmission to the destination device 106. The output interface 116 may be configured to send/transmit, upload, and/or stream the bitstream 110 to the destination device 106 via the transmission medium 104. The output interface 116 may comprise a wired and/or a wireless transmitter configured to send/transmit, upload, and/or stream the bitstream 110 in accordance with one or more proprietary, open-source, and/or standardized communication protocols (e.g., Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol).

The transmission medium 104 may comprise wireless, wired, and/or computer readable medium. For example, the transmission medium 104 may comprise one or more wires, cables, air interfaces, optical discs, flash memory, and/or magnetic memory. The transmission medium 104 may comprise one or more networks (e.g., the internet) or file servers configured to store and/or send/transmit encoded video data.

The destination device 106 may decode the bitstream 110 into the video sequence 108 for display. The destination device 106 may comprise one or more of an input interface 118, a decoder 120, and/or a video display 122. The input interface 118 may be configured to read the bitstream 110 stored on the transmission medium 104 by the source device 102. The input interface 118 may be configured to receive, download, and/or stream the bitstream 110 from the source device 102 via the transmission medium 104. The input interface 118 may comprise a wired and/or a wireless receiver configured to receive, download, and/or stream the bitstream 110 in accordance with one or more proprietary, open-source, standardized communication protocols, and/or any other communication protocol (e.g., such as referenced herein).

The decoder 120 may decode the video sequence 108 from the encoded bitstream 110. The decoder 120 may generate prediction blocks for pictures of the video sequence 108 in a similar manner as the encoder 114 and determine the prediction errors for the blocks, for example, to decode the video sequence 108. The decoder 120 may generate the prediction blocks using/based on prediction types, prediction modes, and/or motion vectors received in the bitstream 110. The decoder 120 may determine the prediction errors using the transform coefficients received in the bitstream 110. The decoder 120 may determine the prediction errors by weighting transform basis functions using the transform coefficients. The decoder 120 may combine the prediction blocks and the prediction errors to decode the video sequence 108. The video sequence 108 at the destination device 106 may be, or may not necessarily be, the same video sequence sent, such as the video sequence 108 as sent by the source device 102. The decoder 120 may decode a video sequence that approximates the video sequence 108, for example, because of lossy compression of the video sequence 108 by the encoder 114 and/or errors introduced into the encoded bitstream 110 during transmission to the destination device 106.

The video display 122 may display the video sequence 108 to a user. The video display 122 may comprise a cathode rate tube (CRT) display, a liquid crystal display (LCD), a plasma display, a light emitting diode (LED) display, and/or any other display device suitable for displaying the video sequence 108.

The video encoding/decoding system 100 is merely an example and video encoding/decoding systems different from the video encoding/decoding system 100 and/or modified versions of the video encoding/decoding system 100 may perform the methods and processes as described herein. For example, the video encoding/decoding system 100 may comprise other components and/or arrangements. The video source 112 may be external to the source device 102. The video display device 122 may be external to the destination device 106 or omitted altogether (e.g., if the video sequence 108 is intended for consumption by a machine and/or storage device). The source device 102 may further comprise a video decoder and the destination device 104 may further comprise a video encoder. For example, the source device 102 may be configured to further receive an encoded bit stream from the destination device 106 to support two-way video transmission between the devices.

The encoder 114 and/or the decoder 120 may operate according to one or more proprietary or industry video coding standards. For example, the encoder 114 and/or the decoder 120 may operate in accordance with one or more proprietary, open-source, and/or standardized protocols (e.g., International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC)), ITU-T H.265 and MPEG-I Part 3 (also known as Versatile Video Coding (VVC)), the WebM VP8 and VP9 codecs, and/or AOMedia Video 1 (AV1), and/or any other video coding protocol).

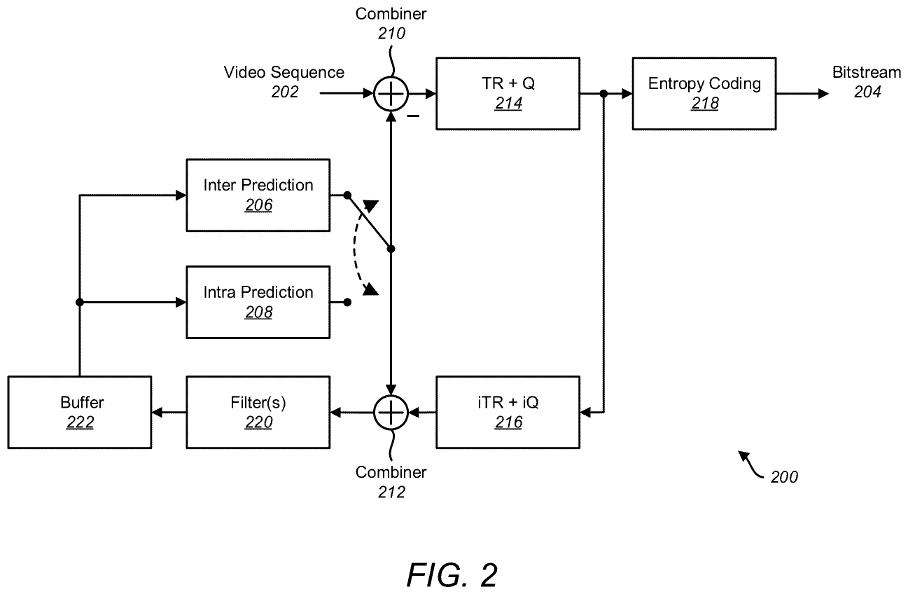

FIG. 2 shows an example encoder. The encoder 200 as shown in FIG. 2 may implement one or more processes described herein. The encoder 200 may encode a video sequence 202 into a bitstream 204 for more efficient storage and/or transmission. The encoder 200 may be implemented in the video coding/decoding system 100 as shown in FIG. 1 (e.g., as the encoder 114) or in any computing, communication, or electronic device (e.g., desktop computer, laptop computer, tablet computer, smart phone, wearable device, television, camera, video gaming console, set-top box, video streaming device, etc.). The encoder 200 may comprise one or more of an inter prediction unit 206, an intra prediction unit 208, combiners 210 and 212, a transform and quantization unit (TR+Q) 214, an inverse transform and quantization unit (iTR+iQ) 216, an entropy coding unit 218, one or more filters 220, and/or a buffer 222.

The encoder 200 may partition pictures (e.g., frames) of (e.g., comprising) the video sequence 202 into blocks and encode the video sequence 202 on a block-by-block basis. The encoder 200 may perform/apply a prediction technique on a block being encoded using either the inter prediction unit 206 or the intra prediction unit 208. The inter prediction unit 206 may perform inter prediction by searching for a block similar to the block being encoded in another, reconstructed picture (e.g., a reference picture) of the video sequence 202. The reconstructed picture may be a picture that was encoded and then decoded. The block determined during the search (e.g., a prediction block) may then be used to predict the block being encoded to remove redundant information. The inter prediction unit 206 may exploit temporal redundancy or similarities in scene content from picture to picture in the video sequence 202 to determine the prediction block. For example, scene content between pictures of the video sequence 202 may be similar except for differences due to motion and/or affine transformation of the screen content over time.

The intra prediction unit 208 may perform intra prediction by forming a prediction block based on data from reconstructed neighboring samples of the block to be encoded within the same picture of the video sequence 202. The reconstructed sample may be a sample that was encoded and then decoded. The intra prediction unit 208 may exploit spatial redundancy or similarities in scene content within a picture of the video sequence 202 to determine the prediction block. For example, the texture of a region of scene content in a picture may be similar to the texture in the immediate surrounding area of the region of the scene content in the same picture.

The combiner 210 may determine a prediction error (e.g., a residual) based on the difference between the block being encoded and the prediction block. The prediction error may represent non-redundant information that may be sent/transmitted to a decoder for accurate decoding of the video sequence 202.

The transform and quantization unit (TR+Q) 214 may transform and quantize the prediction error. The transform and quantization unit 214 may transform the prediction error into transform coefficients by applying, for example, a DCT to reduce correlated information in the prediction error. The transform and quantization unit 214 may quantize the coefficients by mapping data of the transform coefficients to a predefined set of representative values. The transform and quantization unit 214 may quantize the coefficients to reduce irrelevant information in the bitstream 204. The Irrelevant information may be information that may be removed from the coefficients without producing visible and/or perceptible distortion in the video sequence 202 after decoding (e.g., at a receiving device).

The entropy coding unit 218 may apply one or more entropy coding methods to the quantized transform coefficients to further reduce the bit rate. For example, the entropy coding unit 218 may apply context adaptive variable length coding (CAVLC), context adaptive binary arithmetic coding (CABAC), and/or syntax-based context-based binary arithmetic coding (SBAC). The entropy coded coefficients may be packed to form the bitstream 204.

The inverse transform and quantization unit (iTR+iQ) 216 may inverse quantize and inverse transform the quantized transform coefficients to determine a reconstructed prediction error. The combiner 212 may combine the reconstructed prediction error with the prediction block to form a reconstructed block. The filter(s) 220 may filter the reconstructed block, for example, using a deblocking filter and/or a sample-adaptive offset (SAO) filter. The buffer 222 may store the reconstructed block for prediction of one or more other blocks in the same and/or different picture of the video sequence 202.

The encoder 200 may further comprise an encoder control unit. The encoder control unit may be configured to control one or more units of the encoder 200 as shown in FIG. 2. The encoder control unit may control the one or more units of the encoder 200 such that the bitstream 204 may be generated in conformance with the requirements of one or more proprietary coding protocols, industry video coding standards, and/or any other video cording protocol. For example, the encoder control unit may control the one or more units of the encoder 200 such that bitstream 204 may be generated in conformance with one or more of ITU-T H.263, AVC, HEVC, VVC, VP8, VP9, AV1, and/or any other video coding standard/format.

The encoder control unit may attempt to minimize (or reduce) the bitrate of bitstream 204 and/or maximize (or increase) the reconstructed video quality (e.g., within the constraints of a proprietary coding protocol, industry video coding standard, and/or any other video cording protocol). For example, the encoder control unit may attempt to minimize or reduce the bitrate of bitstream 204 such that the reconstructed video quality may not fall below a certain level/threshold, and/or may attempt to maximize or increase the reconstructed video quality such that the bit rate of bitstream 204 may not exceed a certain level/threshold. The encoder control unit may determine/control one or more of: partitioning of the pictures of the video sequence 202 into blocks, whether a block is inter predicted by the inter prediction unit 206 or intra predicted by the intra prediction unit 208, a motion vector for inter prediction of a block, an intra prediction mode among a plurality of intra prediction modes for intra prediction of a block, filtering performed by the filter(s) 220, and/or one or more transform types and/or quantization parameters applied by the transform and quantization unit 214. The encoder control unit may determine/control one or more of the above based on a rate-distortion measure for a block or picture being encoded. The encoder control unit may determine/control one or more of the above to reduce the rate-distortion measure for a block or picture being encoded.

The prediction type used to encode a block (intra or inter prediction), prediction information of the block (intra prediction mode if intra predicted, motion vector, etc.), and/or transform and/or quantization parameters, may be sent to the entropy coding unit 218 to be further compressed (e.g., to reduce the bit rate). The prediction type, prediction information, and/or transform and/or quantization parameters may be packed with the prediction error to form the bitstream 204.

The encoder 200 is merely an example and encoders different from the encoder 200 and/or modified versions of the encoder 200 may perform the methods and processes as described herein. For example, the encoder 200 may comprise other components and/or arrangements. One or more of the components shown in FIG. 2 may be optionally included in the encoder 200 (e.g., the entropy coding unit 218 and/or the filters(s) 220).

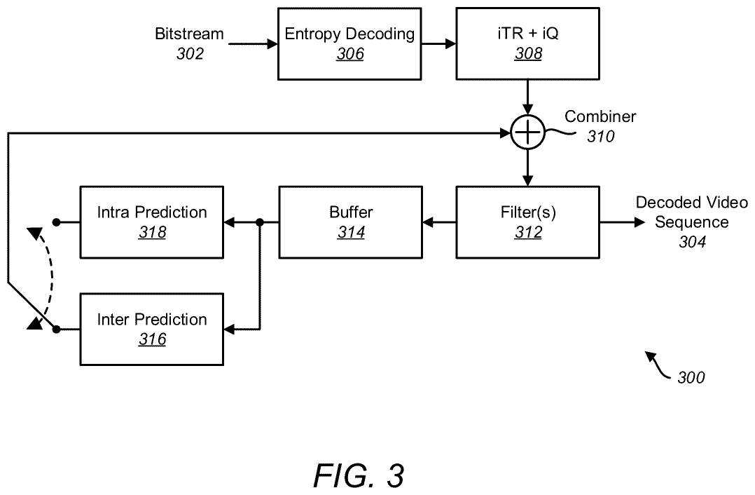

FIG. 3 shows an example decoder. A decoder 300 as shown in FIG. 3 may implement one or more processes described herein. The decoder 300 may decode a bitstream 302 into a decoded video sequence 304 for display and/or some other form of consumption. The decoder 300 may be implemented in the video encoding/decoding system 100 in FIG. 1 and/or in a computing, communication, or electronic device (e.g., desktop computer, laptop computer, tablet computer, smart phone, wearable device, television, camera, video gaming console, set-top box, and/or video streaming device). The decoder 300 may comprise an entropy decoding unit 306, an inverse transform and quantization (iTR+iQ) unit 308, a combiner 310, one or more filters 312, a buffer 314, an inter prediction unit 316, and/or an intra prediction unit 318.

The decoder 300 may comprise a decoder control unit configured to control one or more units of decoder 300. The decoder control unit may control the one or more units of decoder 300 such that the bitstream 302 is decoded in conformance with the requirements of one or more proprietary coding protocols, industry video coding standards, and/or any other communication protocol. For example, the decoder control unit may control the one or more units of decoder 300 such that the bitstream 302 is decoded in conformance with one or more of ITU-T H.263, AVC, HEVC, VVC, VP8, VP9, AV1, and/or any other video coding standard/format.

The decoder control unit may determine/control one or more of: whether a block is inter predicted by the inter prediction unit 316 or intra predicted by the intra prediction unit 318, a motion vector for inter prediction of a block, an intra prediction mode among a plurality of intra prediction modes for intra prediction of a block, filtering performed by the filter(s) 312, and/or one or more inverse transform types and/or inverse quantization parameters to be applied by the inverse transform and quantization unit 308. One or more of the control parameters used by the decoder control unit may be packed in bitstream 302.

The Entropy decoding unit 306 may entropy decode the bitstream 302. The inverse transform and quantization unit 308 may inverse quantize and/or inverse transform the quantized transform coefficients to determine a decoded prediction error. The combiner 310 may combine the decoded prediction error with a prediction block to form a decoded block. The prediction block may be generated by the intra prediction unit 318 or the inter prediction unit 316 (e.g., as described above with respect to encoder 200 in FIG. 2). The filter(s) 312 may filter the decoded block, for example, using a deblocking filter and/or a sample-adaptive offset (SAO) filter. The buffer 314 may store the decoded block for prediction of one or more other blocks in the same and/or different picture of the video sequence in the bitstream 302. The decoded video sequence 304 may be output from the filter(s) 312 as shown in FIG. 3.

The decoder 300 is merely an example and decoders different from the decoder 300 and/or modified versions of the decoder 300 may perform the methods and processes as described herein. For example, the decoder 300 may have other components and/or arrangements. One or more of the components shown in FIG. 3 may be optionally included in the decoder 300 (e.g., the entropy decoding unit 306 and/or the filters(s) 312).

Although not shown in FIGS. 2 and 3, each of the encoder 200 and the decoder 300 may further comprise an intra block copy unit in addition to inter prediction and intra prediction units. The intra block copy unit may perform/operate similar to an inter prediction unit but may predict blocks within the same picture. For example, the intra block copy unit may exploit repeated patterns that appear in screen content. The screen content may include computer generated text, graphics, animation, etc.

Video encoding and/or decoding may be performed on a block-by-block basis. The process of partitioning a picture into blocks may be adaptive based on the content of the picture. For example, larger block partitions may be used in areas of a picture with higher levels of homogeneity to improve coding efficiency.

A picture (e.g., in HEVC, or any other coding standard/format) may be partitioned into non-overlapping square blocks, which may be referred to as coding tree blocks (CTBs). The CTBs may comprise samples of a sample array. A CTB may have a size of 2n×2n samples, where n may be specified by a parameter of the encoding system. For example, n may be 4, 5, 6, or any other value. A CTB may have any other size. A CTB may be further partitioned by a recursive quadtree partitioning into coding blocks (CBs) of half vertical and half horizontal size. The CTB may form the root of the quadtree. A CB that is not split further as part of the recursive quadtree partitioning may be referred to as a leaf CB of the quadtree, and otherwise may be referred to as a non-leaf CB of the quadtree. A CB may have a minimum size specified by a parameter of the encoding system. For example, a CB may have a minimum size of 4×4, 8×8, 16×16, 32×32, 64×64 samples, or any other minimum size. A CB may be further partitioned into one or more prediction blocks (PBs) for performing inter and/or intra prediction. A PB may be a rectangular block of samples on which the same prediction type/mode may be applied. For transformations, a CB may be partitioned into one or more transform blocks (TBs). A TB may be a rectangular block of samples that may determine/indicate an applied transform size.

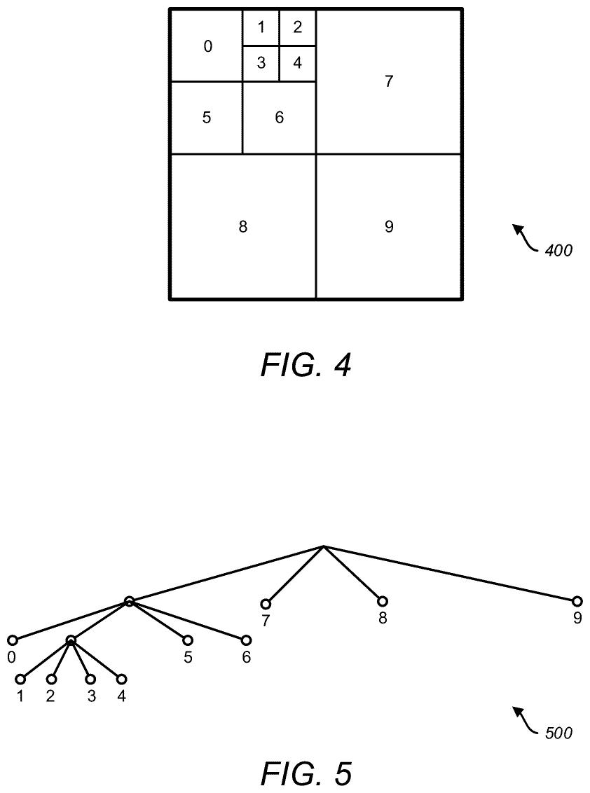

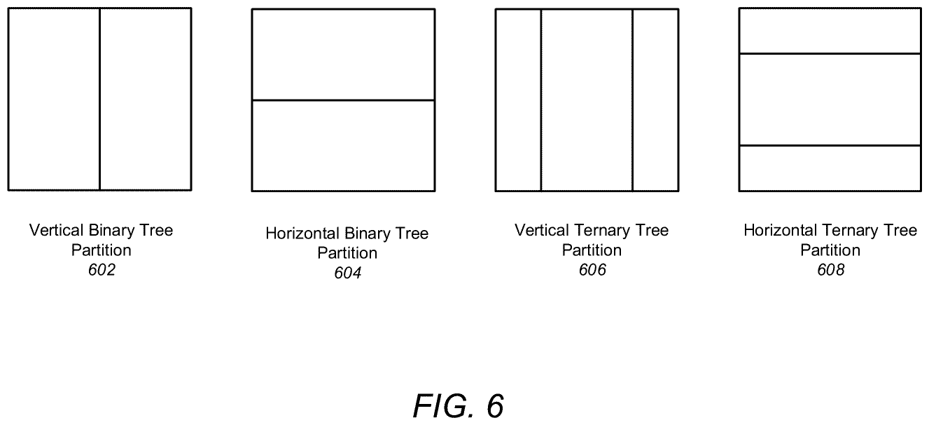

FIG. 4 shows an example quadtree partitioning of a CTB. FIG. 5 shows a quadtree corresponding to the example quadtree partitioning of the CTB 400 in FIG. 4. As shown in FIGS. 4 and 5, the CTB 400 may first be partitioned into four CBs of half vertical and half horizontal size. Three of the resulting CBs of the first level partitioning of CTB 400 may be leaf CBs. The three leaf CBs of the first level partitioning of CTB 400 are respectively labeled 7, 8, and 9 in FIGS. 4 and 5. The non-leaf CB of the first level partitioning of CTB 400 may be partitioned into four sub-CBs of half vertical and half horizontal size. Three of the resulting sub-CBs of the second level partitioning of CTB 400 may be leaf CBs. The three leaf CBs of the second level partitioning of CTB 400 are respectively labeled 0, 5, and 6 in FIGS. 4 and 5. The non-leaf CB of the second level partitioning of CTB 400 may be partitioned into four leaf CBs of half vertical and half horizontal size. The four leaf CBs may be respectively labeled 1, 2, 3, and 4 in FIGS. 4 and 5.

The CTB 400 of FIG. 4 may be partitioned into 10 leaf CBs respectively labeled 0-9, and/or any other quantity of leaf CBs. The 10 leaf CBs may correspond to 10 CB leaf nodes (e.g., 10 CB leaf nodes of the quadtree 500 as shown in FIG. 5). In other examples, a CTB may be partitioned into a different number of leaf CBs. The resulting quadtree partitioning of the CTB 400 may be scanned using a z-scan (e.g., left-to-right, top-to-bottom) to form the sequence order for encoding/decoding the CB leaf nodes. A numeric label (e.g., indicator, index) of each CB leaf node in FIGS. 4 and 5 may correspond to the sequence order for encoding/decoding. For example, CB leaf node 0 may be encoded/decoded first and CB leaf node 9 may be encoded/decoded last. Although not shown in FIGS. 4 and 5, each CB leaf node may comprise one or more PBs and/or TBs.

A picture, in VVC (or in any other coding standard/format), may be partitioned in a similar manner (such as in HEVC). A picture may be first partitioned into non-overlapping square CTBs. The CTBs may then be partitioned, using a recursive quadtree partitioning, into CBs of half vertical and half horizontal size. A quadtree leaf node (e.g., in VVC) may be further partitioned by a binary tree or ternary tree partitioning (or any other partitioning) into CBs of unequal sizes.

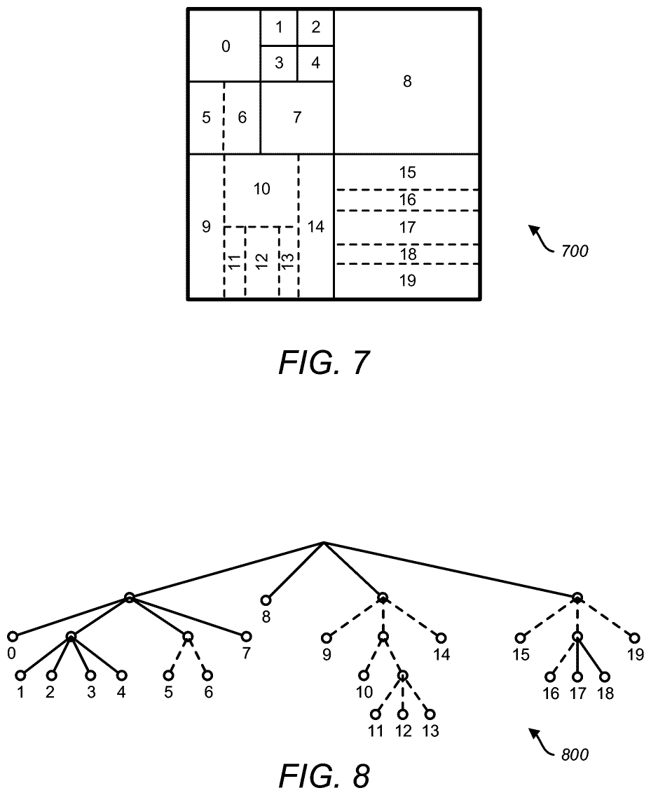

FIG. 6 shows example binary tree and ternary tree partitions. A binary tree partition may divide a parent block in half in either a vertical direction 602 or a horizontal direction 604. The resulting partitions may be half in size as compared to the parent block. The resulting partitions may correspond to sizes that are less than and/or greater than half of the parent block size. A ternary tree partition may divide a parent block into three parts in either a vertical direction 606 or a horizontal direction 608. FIG. 6 shows an example in which the middle partition may be twice as large as the other two end partitions in the ternary tree partitions. In other examples, partitions may be of other sizes relative to each other and to the parent block. Binary and ternary tree partitions are examples of multi-type tree partitioning. Multi-type tree partitions may comprise partitioning a parent block into other quantities of smaller blocks. The block partitioning strategy (e.g., in VVC) may be referred to as a combination of quadtree and multi-type tree partitioning (quadtree+multi-type tree partitioning) because of the addition of binary and/or ternary tree partitioning to quadtree partitioning.

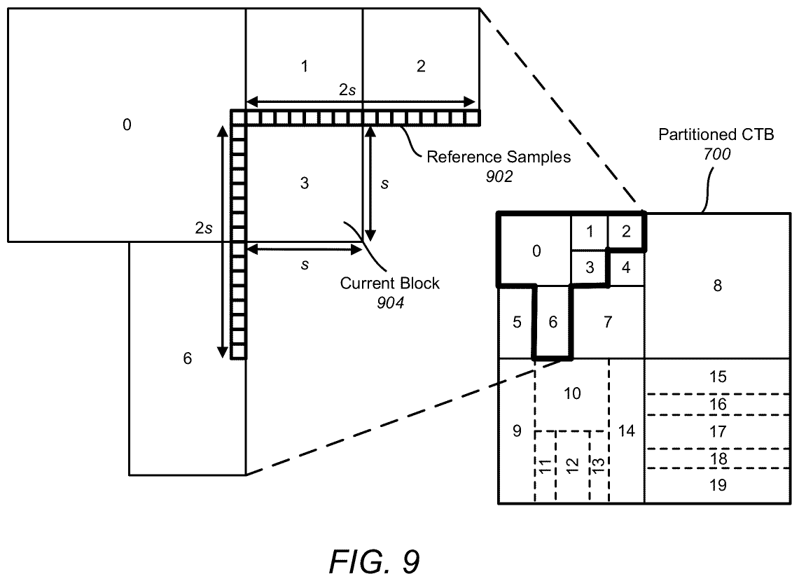

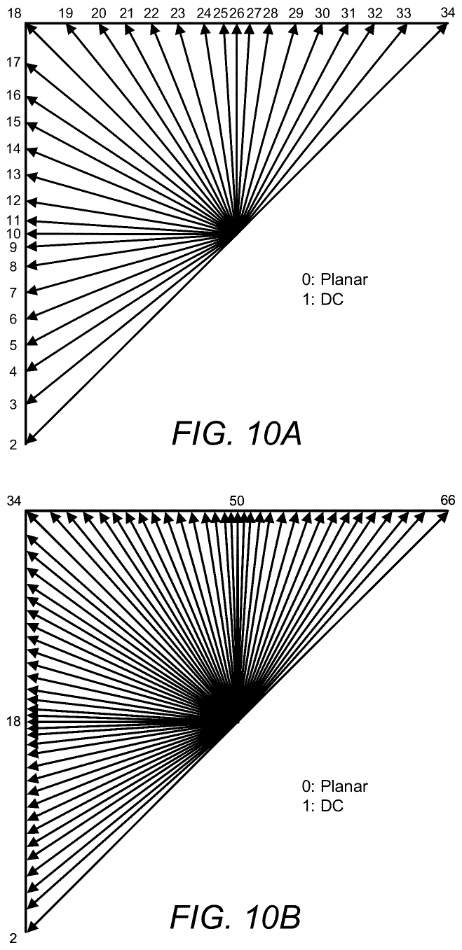

FIG. 7 shows an example of combined quadtree and multi-type tree partitioning of a CTB. FIG. 8 shows a tree corresponding to the combined quadtree and multi-type tree partitioning of the CTB 700 shown in FIG. 7. In both FIGS. 7 and 8, quadtree splits are shown in solid lines and multi-type tree splits are shown in dashed lines. The CTB 700 is shown with the same quadtree partitioning as the CTB 400 described in FIG. 4, and a description of the quadtree partitioning of the CTB 700 is omitted. The quadtree partitioning of the CTB 700 is merely an example and a CTB may be quadtree partitioned in a manner different from the CTB 700. Additional multi-type tree partitions of the CTB 700 may be made relative to three leaf CBs shown in FIG. 4. The three leaf CBs in FIG. 4 that are shown in FIG. 7 as being further partitioned may be leaf CBs 5, 8, and 9. The three leaf CBs may be further partitioned using one or more binary and/or ternary tree partitions.

The leaf CB 5 of FIG. 4 may be partitioned into two CBs based on a vertical binary tree partitioning. The two resulting CBs may be leaf CBs respectively labeled 5 and 6 in FIGS. 7 and 8. The leaf CB 8 of FIG. 4 may be partitioned into three CBs based on a vertical ternary tree partition. Two of the three resulting CBs may be leaf CBs respectively labeled 9 and 14 in FIGS. 7 and 8. The remaining, non-leaf CB may be partitioned first into two CBs based on a horizontal binary tree partition. One of the two CBs may be a leaf CB labeled 10. The other of the two CBs may be further partitioned into three CBs based on a vertical ternary tree partition. The resulting three CBs may be leaf CBs respectively labeled 11, 12, and 13 in FIGS. 7 and 8. The leaf CB 9 of FIG. 4 may be partitioned into three CBs based on a horizontal ternary tree partition. Two of the three CBs may be leaf CBs respectively labeled 15 and 19 in FIGS. 7 and 8. The remaining, non-leaf CB may be partitioned into three CBs based on another horizontal ternary tree partition. The resulting three CBs may all be leaf CBs respectively labeled 16, 17, and 18 in FIGS. 7 and 8.

Altogether, the CTB 700 may be partitioned into 20 leaf CBs respectively labeled 0-19. The 20 leaf CBs may correspond to 20 leaf nodes (e.g., 20 leaf nodes of the tree 800 shown in FIG. 8). The resulting combination of quadtree and multi-type tree partitioning of the CTB 700 may be scanned using a z-scan (left-to-right, top-to-bottom) to form the sequence order for encoding/decoding the CB leaf nodes. A numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and/or TBs.

A coding standard/format (e.g., HEVC, VVC, or any other coding standard/format) may define various units (e.g., in addition to specifying various blocks (e.g., CTBs, CBs, PBs, TBs)). Blocks may comprise a rectangular area of samples in a sample array. Units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bit stream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

A block may refer to any of a CTB, CB, PB, TB, CTU, CU, PU, and/or TU (e.g., in the context of HEVC, VVC, or any other coding format/standard). A block may be used to refer to similar data structures in the context of any video coding format/standard/protocol. For example, a block may refer to a macroblock in the AVC standard, a macroblock or a sub-block in the VP8 coding format, a superblock or a sub-block in the VP9 coding format, and/or a superblock or a sub-block in the AV1 coding format.

Samples of a block to be encoded (e.g., a current block) may be predicted from samples of the column immediately adjacent to the left-most column of the current block and samples of the row immediately adjacent to the top-most row of the current block, such as in intra prediction. The samples from the immediately adjacent column and row may be jointly referred to as reference samples. Each sample of the current block may be predicted (e.g., in an intra prediction mode) by projecting the position of the sample in the current block in a given direction to a point along the reference samples. The sample may be predicted by interpolating between the two closest reference samples of the projection point if the projection does not fall directly on a reference sample. A prediction error (e.g., a residual) may be determined for the current block based on differences between the predicted sample values and the original sample values of the current block.

Predicting samples and determining a prediction error based on a difference between the predicted samples and original samples may be performed (e.g., at an encoder) for a plurality of different intra prediction modes (e.g., including non-directional intra prediction modes). The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block, using the intra prediction mode indicated by the encoder, and/or combining the predicted samples with the prediction error.

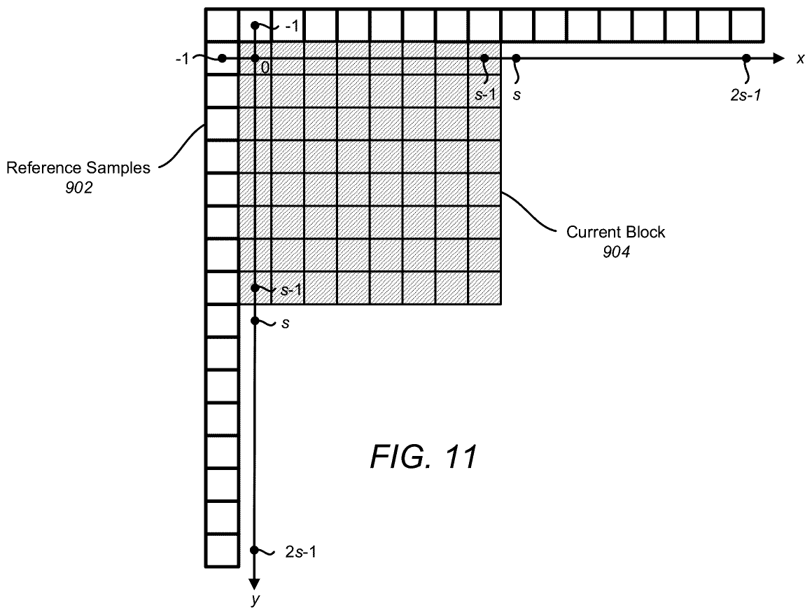

FIG. 9 shows an example set of reference samples determined for intra prediction of a current block. The current block 904 may correspond to a block being encoded and/or decoded. The current block 904 may correspond to block 3 of the partitioned CTB 700 as shown in FIG. 7. As described herein, the numeric labels 0-19 of the blocks of partitioned CTB 700 may correspond to the sequence order for encoding/decoding the blocks and may be used as such in the example of FIG. 9.

The current block 904 may be w×h samples in size. The reference samples 902 may comprise: 2w samples (or any other quantity of samples) of the row immediately adjacent to the top-most row of the current block 904, 2h samples (or any other quantity of samples) of the column immediately adjacent to the left-most column of the current block 904, and the top left neighboring corner sample to the current block 904. The current block 904 may be square, such that w=h=s. In other examples, a current block need not be square, such that w≠h. Available samples from neighboring blocks of the current block 904 may be used for constructing the set of reference samples 902. Samples may not be available for constructing the set of reference samples 902, for example, if the samples lie outside the picture of the current block, the samples are part of a different slice of the current block (e.g., if the concept of slices is used), and/or the samples belong to blocks that have been inter coded and constrained intra prediction is indicated. Intra prediction may not be dependent on inter predicted blocks, for example, if constrained intra prediction is indicated.

Samples that may not be available for constructing the set of reference samples 902 may comprise samples in blocks that have not already been encoded and reconstructed at an encoder and/or decoded at a decoder based on the sequence order for encoding/decoding. Restriction of such samples from inclusion in the set of reference samples 902 may allow identical prediction results to be determined at both the encoder and decoder. Samples from neighboring blocks 0, 1, and 2 may be available to construct the reference samples 902 given that these blocks are encoded and reconstructed at an encoder and decoded at a decoder prior to coding of the current block 904. The samples from neighboring blocks 0, 1, and 2 may be available to construct reference samples 902, for example, if there are no other issues (e.g., as mentioned above) preventing the availability of the samples from the neighboring blocks 0, 1, and 2. The portion of reference samples 902 from neighboring block 6 may not be available due to the sequence order for encoding/decoding (e.g., because the block 6 may not have already been encoded and reconstructed at the encoder and/or decoded at the decoder based on the sequence order for encoding/decoding).

Unavailable samples from the reference samples 902 may be filled with one or more of the available reference samples 902. For example, an unavailable reference sample may be filled with a nearest available reference sample. The nearest available reference sample may be determined by moving in a clock-wise direction through the reference samples 902 from the position of the unavailable reference. The reference samples 902 may be filled with the mid-value of the dynamic range of the picture being coded, for example, if no reference samples are available.

The reference samples 902 may be filtered based on the size of current block 904 being coded and an applied intra prediction mode. FIG. 9 shows an exemplary determination of reference samples for intra prediction of a block. Reference samples may be determined in a different manner than described above. For example, multiple reference lines may be used in other instances (e.g., in VVC).

Samples of the current block 904 may be intra predicted based on the reference samples 902, for example, based on (e.g., after) determination and (optionally) filtration of the reference samples. At least some (e.g., most) encoders/decoders may support a plurality of intra prediction modes in accordance with one or more video coding standards. For example, HEVC supports 35 intra prediction modes, including a planar mode, a direct current (DC) mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture. Any quantity of intra prediction modes may be supported.

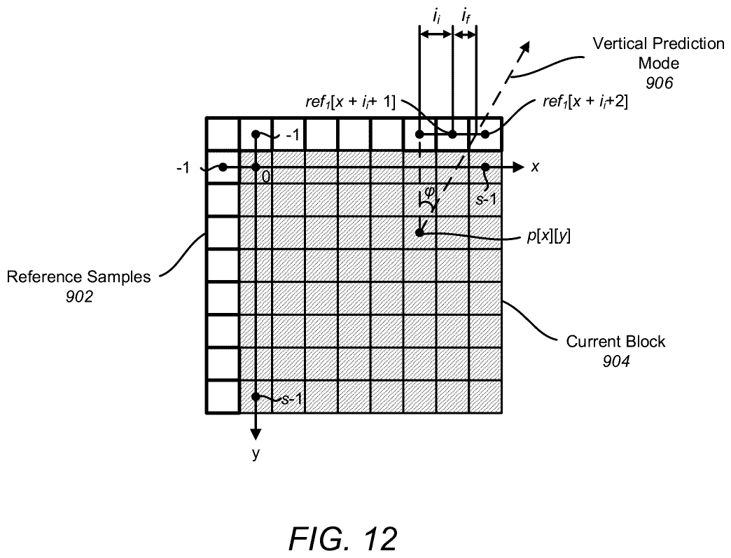

FIGS. 10A and 10B show example intra prediction modes. FIG. 10A shows 35 intra prediction modes, such as supported by HEVC. The 35 intra prediction modes may be indicated/identified by indices 0 to 34. Prediction mode 0 may correspond to planar mode. Prediction mode 1 may correspond to DC mode. Prediction modes 2-34 may correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B shows 67 intra prediction modes, such as supported by VVC. The 67 intra prediction modes may be indicated/identified by indices 0 to 66. Prediction mode 0 may correspond to planar mode. Prediction mode 1 corresponds to DC mode. Prediction modes 2-66 may correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Some of the intra prediction modes illustrated in FIG. 10B may be adaptively replaced by wide-angle directions because blocks in VVC need not be squares.

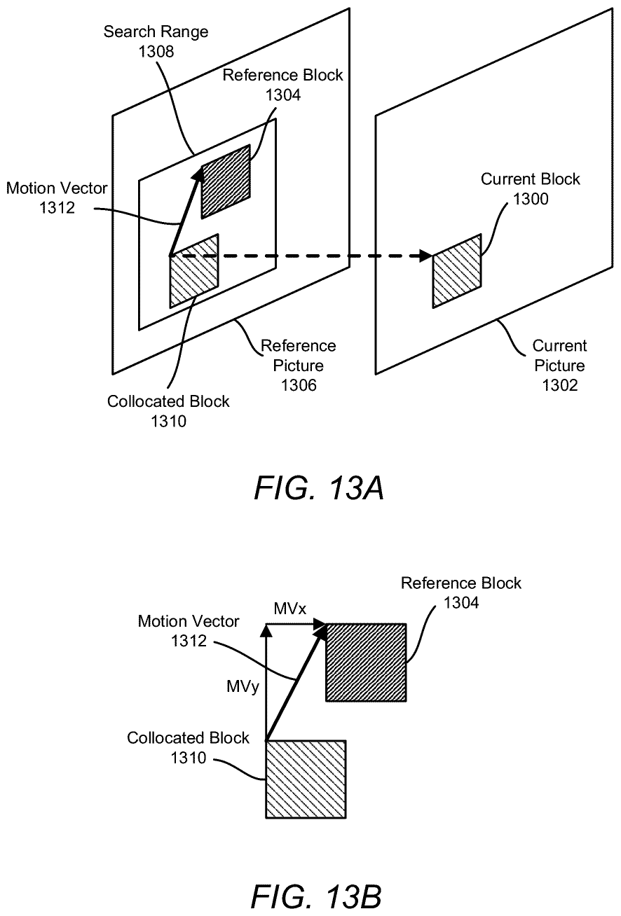

FIG. 11 shows a current block and corresponding reference samples. In FIG. 11, the current block 904 and the reference samples 902 from FIG. 9 are shown in a two-dimensional x, y plane, where a sample may be referenced as p[x][y]. In order to simplify the prediction process, the reference samples 902 may be placed in two, one-dimensional arrays. The reference samples 902, above the current block 904, may be placed in the one-dimensional array ref₁[x]:

ref₁[x]=p[−1+x][−1],(x≥0) (1)

The reference samples 902 to the left of the current block 904 may be placed in the one-dimensional array ref₂[y]:

ref₂[y]=p[−1][−1+y],(y≥0) (2)

The prediction process may comprise determination of a predicted sample p [x] [y] (e.g., a predicted value) at a location [x] [y] in the current block 904. For planar mode, a sample at the location [x][y] in the current block 904 may be predicted by determining/calculating the mean of two interpolated values. The first of the two interpolated values may be based on a horizontal linear interpolation at the location [x] [y] in the current block 904. The second of the two interpolated values may be based on a vertical linear interpolation at the location [x][y] in the current block 904. The predicted sample p[x] [y] in the current block 904 may be determined/calculated as:

$$p [ x ] ⌈ y ] = \frac{1}{2 \cdot s} ( h [ x ] [ y ] + v [ x ] [ y ] + s ) , \qquad ( 3 )$$

$$where h [ x ] [ y ] = ( s - x - 1 ) \cdot {ref}_{2} [ y ] + ( x + 1 ) \cdot {ref}_{1} [ s ] \qquad ( 4 )$$

may be the horizontal linear interpolation at the location [x] [y] in the current block 904 and

v[x][y]=(s−y−1)·ref₁[x]+(y+1)·ref₂[s] (5)

may be the vertical linear interpolation at the location [x] [y] in the current block 904. s may be equal to a length of a side (e.g., a number of samples on a side) of the current block 904.

A sample at a location [x] [y] in the current block 904 may be predicted by the mean of the reference samples 902, such as for a DC mode. The predicted sample p[x][y] in the current block 904 may be determined/calculated as:

$$p [ x ] ⌈ y ] = \frac{1}{2 \cdot s} ( {\sum }_{x = 0}^{s - 1} r e {f}_{1} [ x ] + {\sum }_{y = 0}^{s - 1} r e {f}_{2} [ y ] ) . \qquad ( 6 )$$

A sample at a location [x][y] in the current block 904 may be predicted by projecting the location [x][y] in a direction specified by a given angular mode to a point on the horizontal or vertical line of samples comprising the reference samples 902, such as for an angular mode. The sample at the location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC). The direction specified by the angular mode may be given by an angle φ defined relative to the x-axis for horizontal prediction modes (e.g., modes 2-18 in HEVC and modes 2-34 in VVC).

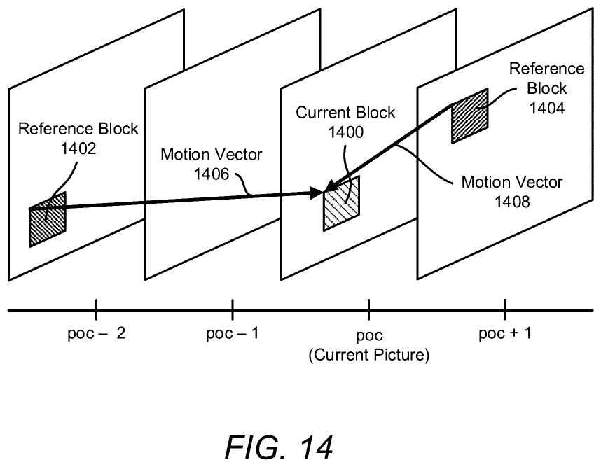

FIG. 12 shows an example application of an intra prediction mode for prediction of a current block. FIG. 12 specifically shows prediction of a sample at a location [x] [y] in the current block 904 for a vertical prediction mode 906. The vertical prediction mode 906 may be given by an angle φ with respect to the vertical axis. The location [x] [y] in the current block 904, in vertical prediction modes, may be projected to a point (e.g., a projection point) on the horizontal line of reference samples ref₁[x]. The reference samples 902 are only partially shown in FIG. 12 for ease of illustration. As shown in FIG. 12, the projection point on the horizontal line of reference samples ref₁[x] may not be exactly on a reference sample. A predicted sample p[x] [y] in the current block 904 may be determined/calculated by linearly interpolating between the two reference samples, for example, if the projection point falls at a fractional sample position between two reference samples. The predicted sample p[x][y] may be determined/calculated as:

p[x][y]=(1−i_{f})·ref₁[x+iᵢ+1]+i_{f}·ref₁[x+iᵢ+2] (7)

iᵢ may be the integer part of the horizontal displacement of the projection point relative to the location [x][y]. iᵢ may be determined/calculated as a function of the tangent of the angle φ of the vertical prediction mode 906 as:

iᵢ=└(y+1)·tan φ┘.

i_{f} may be the fractional part of the horizontal displacement of the projection point relative to the location [x][y] and may be determined/calculated as:

i_{f}=((y+1)·tan φ)−└(y+1)·tan φ┘,

where └·┘ is the integer floor function.

A location [x][y] of a sample in the current block 904 may be projected onto the vertical line of reference samples ref₂ [y], such as for horizontal prediction modes. A predicted sample p[x] [y for horizontal prediction modes may be determined/calculated as:

p[x][y]=(1−i_{f})·ref₂[y+iᵢ+1]+i_{f}·ref₂[y+iᵢ+2] (10)

iᵢ may be the integer part of the vertical displacement of the projection point relative to the location [x] [y]. iᵢ may be determined/calculated as a function of the tangent of the angle φ of the horizontal prediction mode as:

iᵢ=└x+1)·tan φ┘ (11)

iᵢ may be the fractional part of the vertical displacement of the projection point relative to the location [x][y]. iᵢ may be determined/calculated as:

i_{f}=((x+1)·tan φ)−└(x+1)·tan φ┘ (12)

where └·┘ is the integer floor function.

The interpolation functions given by Equations (7) and (10) may be implemented by an encoder and/or a decoder (e.g., the encoder 200 in FIG. 2 and/or the decoder 300 in FIG. 3). The interpolation functions may be implemented by finite impulse response (FIR) filters. For example, the interpolation functions may be implemented as a set of two-tap FIR filters. The coefficients of the two-tap FIR filters may be respectively given by (1-i_{f}) and i_{f}. The predicted sample p[x][y], in angular intra prediction, may be calculated with some predefined level of sample accuracy (e.g., 1/32 sample accuracy, or accuracy defined by any other metric). For 1/32 sample accuracy, the set of two-tap FIR interpolation filters may comprise up to 32 different two-tap FIR interpolation filters one for each of the 32 possible values of the fractional part of the projected displacement if. In other examples, different levels of sample accuracy may be used.

The FIR filters may be used for predicting chroma samples and/or luma samples. For example, the two-tap interpolation FIR filter may be used for predicting chroma samples and a same and/or a different interpolation technique/filter may be used for luma samples. For example, a four-tap FIR filter may be used to determine a predicted value of a luma sample. Coefficients of the four tap FIR filter may be determined based on if (e.g., similar to the two-tap FIR filter). For 1/32 sample accuracy, a set of 32 different four-tap FIR filters may comprise up to 32 different four-tap FIR filters one for each of the 32 possible values of the fractional part of the projected displacement i_{f}. In other examples, different levels of sample accuracy may be used. The set of four-tap FIR filters may be stored in a look-up table (LUT) and referenced based on i_{f}. A predicted sample p[x][y], for vertical prediction modes, may be determined based on the four-tap FIR filter as:

$$p [ x ] [ y ] = {\sum }_{i = 0}^{3} f T [ i ] \cdot {ref}_{1} [ x + iIdx + i ] , \qquad ( 13 )$$

where fT[i], i=0 . . . 0.3, may be the filter coefficients, and Idx is integer displacement. A predicted sample p[x] [y], for horizontal prediction modes, may be determined based on the four-tap FIR filter as:

$$p [ x ] ⌈ y ] = {\sum }_{i = 0}^{3} f T [ i ] \cdot {ref}_{2} [ y + iIdx + i ] . \qquad ( 14 )$$

Supplementary reference samples may be determined/constructed if the location [x][y] of a sample in the current block 904 to be predicted is projected to a negative x coordinate. The location [x][y] of a sample may be projected to a negative x coordinate, for example, if negative vertical prediction angles φ are used. The supplementary reference samples may be determined/constructed by projecting the reference samples in [symbol] ref [symbol] _2 [y] in the vertical line of reference samples 902 to the horizontal line of reference samples 902 using the negative vertical prediction angle φ. Supplementary reference samples may be similarly determined/constructed, for example, if the location [x][y] of a sample in the current block 904 to be predicted is projected to a negative y coordinate. The location [x][y] of a sample may be projected to a negative y coordinate, for example, if negative horizontal prediction angles φ are used. The supplementary reference samples may be determined/constructed by projecting the reference samples in [symbol] ref [symbol] _1 [x] on the horizontal line of reference samples 902 to the vertical line of reference samples 902 using the negative horizontal prediction angle φ.

An encoder may determine/predict samples of a current block being encoded (e.g., the current block 904) for a plurality of intra prediction modes (e.g., using one or more of the functions described herein). For example, an encoder may determine/predict samples of a current block for each of 35 intra prediction modes in HEVC and/or 67 intra prediction modes in VVC. The encoder may determine, for each intra prediction mode applied, a corresponding prediction error for the current block based on a difference (e.g., sum of squared differences (SSD), sum of absolute differences (SAD), or sum of absolute transformed differences (SATD)) between the prediction samples determined for the intra prediction mode and the original samples of the current block. The encoder may determine/select one of the intra prediction modes to encode the current block based on the determined prediction errors. For example, the encoder may determine/select one of the intra prediction modes that results in the smallest prediction error for the current block. The encoder may determine/select the intra prediction mode to encode the current block based on a rate-distortion measure (e.g., Lagrangian rate-distortion cost) determined using the prediction errors. The encoder may send an indication of the determined/selected intra prediction mode and its corresponding prediction error (e.g., residual) to a decoder for decoding of the current block.

A decoder may determine/predict samples of a current block being decoded (e.g., the current block 904) for an intra prediction mode. For example, a decoder may receive an indication of an intra prediction mode (e.g., an angular intra prediction mode) from an encoder for a current block. The decoder may construct a set of reference samples and perform intra prediction based on the intra prediction mode indicated by the encoder for the current block in a similar manner (e.g., as described above for the encoder). The decoder may add predicted values of the samples (e.g., determined based on the intra prediction mode) of the current block to a residual of the current block to reconstruct the current block. A decoder need not receive an indication of an angular intra prediction mode from an encoder for a current block. A decoder may determine an intra prediction mode, for example, based on other criteria. While various examples herein correspond to intra prediction modes in HEVC and VVC, the methods, devices, and systems as described herein may be applied to/used for other intra prediction modes (e.g., as used in other video coding standards/formats, such as VP8, VP9, AV1, etc.).

Intra prediction may exploit correlations between spatially neighboring samples in the same picture of a video sequence to perform video compression. Inter prediction is another coding tool that may be used to perform video compression. Inter prediction may exploit correlations in the time domain between blocks of samples in different pictures of a video sequence. For example, an object may be seen across multiple pictures of a video sequence. The object may move (e.g., by some translation and/or affine motion) or remain stationary across the multiple pictures. A current block of samples in a current picture being encoded may have/be associated with a corresponding block of samples in a previously decoded picture. The corresponding block of samples may accurately predict the current block of samples. The corresponding block of samples may be displaced from the current block of samples, for example, due to movement of the object, represented in both blocks, across the respective pictures of the blocks. The previously decoded picture may be a reference picture. The corresponding block of samples in the reference picture may be a reference block for motion compensated prediction. An encoder may use a block matching technique to estimate the displacement (or motion) of the object and/or to determine the reference block in the reference picture.

An encoder may determine a difference between a current block and a prediction for a current block. An encoder may determine a difference, for example, based on/after determining/generating a prediction for a current block (e.g., using inter prediction). The difference may be a prediction error and/or as a residual. The encoder may store and/or send (e.g., signal), in/via a bitstream, the prediction error and/or other related prediction information. The prediction error and/or other related prediction information may be used for decoding and/or other forms of consumption. A decoder may decode the current block by predicting the samples of the current block (e.g., by using the related prediction information) and combining the predicted samples with the prediction error.

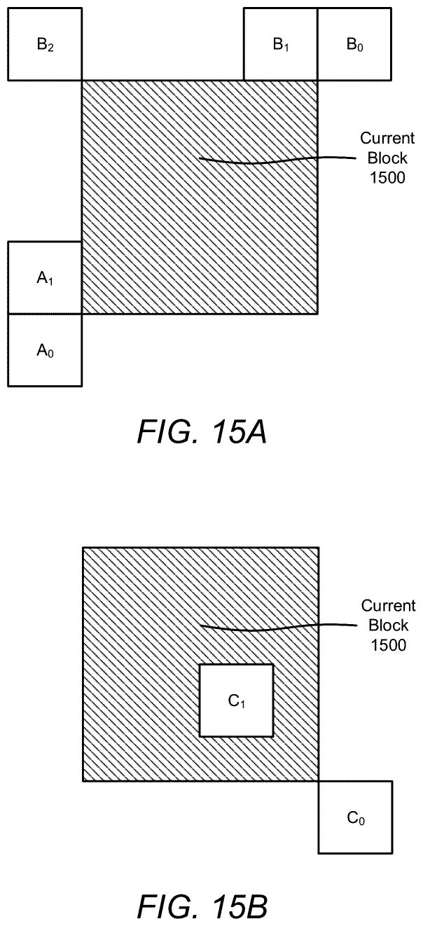

FIG. 13A shows an example of inter prediction. The inter prediction may be performed for a current block 1300 in a current picture 1302 being encoded. An encoder (e.g., the encoder 200 as shown in FIG. 2) may perform inter prediction to determine and/or generate a reference block 1304 in a reference picture 1306. The reference block 1304 may be used to predict the current block 1300. Reference pictures (e.g., the reference picture 1306) may be prior decoded pictures available at the encoder and/or a decoder. Availability of a prior decoded picture may depend/be based on whether the prior decoded picture is available in a decoded picture buffer, at the time, the current block 1300 is being encoded and/or decoded. The encoder may search the one or more reference pictures 1306 for a block that is similar (or substantially similar) to the current block 1300. The encoder may determine the best matching block from the blocks tested during the searching process. The best matching block may be a reference block 1304. The encoder may determine that the reference block 1304 is the best matching reference block based on one or more cost criteria. The one or more cost criteria may comprise a rate-distortion criterion (e.g., Lagrangian rate-distortion cost). The one or more cost criteria may be based on a difference (e.g., SSD, SAD, and/or SATD) between prediction samples of the reference block 1304 and original samples of the current block 1300.

The encoder may search for the reference block 1304 within a reference region (e.g., a search range 1308). The reference region (e.g., a search range 1308) may be positioned around a collocated position (or block) 1310, of the current block 1300, in the reference picture 1306. The collocated block 1310 may have a same position in the reference picture 1306 as the current block 1300 in the current picture 1302. The reference region (e.g., a search range 1308) may at least partially extend outside of the reference picture 1306. Constant boundary extension may be used, for example, if the reference region (e.g., a search range 1308) extends outside of the reference picture 1306. The constant boundary extension may be used such that values of the samples in a row or a column of reference picture 1306, immediately adjacent to a portion of the reference region (e.g., a search range 1308) extending outside of the reference picture 1306, may be used for sample locations outside of the reference picture 1306. A subset of potential positions, or all potential positions, within the reference region (e.g., a search range 1308) may be searched for the reference block 1304. The encoder may utilize one or more search implementations to determine and/or generate the reference block 1304. For example, the encoder may determine a set of candidate search positions based on motion information of neighboring blocks (e.g., a motion vector 1312) to the current block 1300.

One or more reference pictures may be searched by the encoder during inter prediction to determine and/or generate the best matching reference block. The reference pictures searched by the encoder may be included in (e.g., added to) one or more reference picture lists. For example, in HEVC and VVC (and/or in one or more other communication protocols), two reference picture lists may be used (e.g., a reference picture list 0 and a reference picture list 1). A reference picture list may include one or more pictures. The reference picture 1306 of the reference block 1304 may be indicated by a reference index pointing into a reference picture list comprising the reference picture 1306.

FIG. 13B shows an example motion vector. A displacement between the reference block 1304 and the current block 1300 may be interpreted as an estimate of the motion between the reference block 1304 and the current block 1300 across their respective pictures. The displacement may be represented by a motion vector 1312. For example, the motion vector 1312 may be indicated by a horizontal component (MVx) and a vertical component (MVy) relative to the position of the current block 1300. A motion vector (e.g., the motion vector 1312) may have fractional or integer resolution. A motion vector with fractional resolution may point between two samples in a reference picture to provide a better estimation of the motion of the current block 1300. For example, a motion vector may have ½, ¼, ⅛, 1/16, 1/32, or any other fractional sample resolution. Interpolation between the two samples at integer positions may be used to generate a reference block and its corresponding samples at fractional positions, for example, if a motion vector points to a non-integer sample value in the reference picture. The interpolation may be performed by a filter with two or more taps.

The encoder may determine a difference (e.g., a corresponding sample-by-sample difference) between the reference block 1304 and the current block 1300. The encoder may determine the difference between the reference block 1304 and the current block 1300, for example, based on/after the reference block 1304 is determined and/or generated, using inter prediction, for the current block 1300. The difference may be a prediction error and/or a residual. The encoder may store and/or send (e.g., signal), in/via a bitstream, the prediction error and/or related motion information. The prediction error and/or the related motion information may be used for decoding (e.g., decoding the current block 1300) and/or other forms of consumption. The motion information may comprise the motion vector 1312 and/or a reference indicator/index. The reference indicator may indicate the reference picture 1306 in a reference picture list. The motion information may comprise an indication of the motion vector 1312 and/or an indication of the reference index. The reference index may indicate reference picture 1306 in the reference picture list. A decoder may decode the current block 1300 by determining and/or generating the reference block 1304. The decoder may determine and/or generate the reference block 1304, for example, based on the prediction error and/or the related motion information. The reference block 1304 may correspond to/form (e.g., be considered as) a prediction of the current block 1300. The decoder may decode the current block 1300 based on combining the prediction with the prediction error.

Inter prediction, as shown in FIG. 13A, may be performed using one reference picture 1306 as a source of a prediction for the current block 1300. Inter prediction based on a prediction of a current block using a single picture may be referred to as uni-prediction.

Inter prediction of a current block, using bi-prediction, may be based on two pictures. Bi-prediction may be useful, for example, if a video sequence comprises fast motion, camera panning, zooming, and/or scene changes. Bi-prediction may be useful to capture fade outs of one scene or fade outs from one scene to another, where two pictures may effectively be displayed simultaneously with different levels of intensity.

One or both of uni-prediction and bi-prediction may be available/used for performing inter prediction (e.g., at an encoder and/or at a decoder). Performing a specific type of inter prediction (e.g., uni-prediction and/or bi-prediction) may depend on a slice type of current block. For example, for P slices, only uni-prediction may be available/used for performing inter prediction. For B slices, either uni-prediction or bi-prediction may be available/used for performing inter prediction. An encoder may determine and/or generate a reference block, for predicting a current block, from a reference picture list 0, for example, if the encoder is using uni-prediction. An encoder may determine and/or generate a first reference block, for predicting a current block, from a reference picture list 0 and determine and/or generate a second reference block, for predicting the current block, from a reference picture list 1, for example, if the encoder is using bi-prediction.

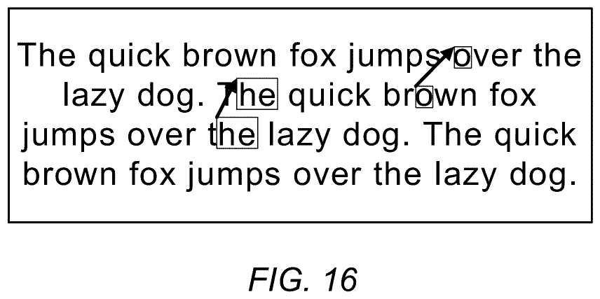

FIG. 14 shows an example of bi-prediction. Two reference blocks 1402 and 1404 may be used to predict a current block 1400. The reference block 1402 may be in a reference picture of one of reference picture list 0 or reference picture list 1. The reference block 1404 may be in a reference picture of another one of reference picture list 0 or reference picture list 1. As shown in FIG. 14, the reference block 1402 may be in a first picture that precedes (e.g., in time) a current picture of the current block 1400, and the reference block 1404 may be in a second picture that succeeds (e.g., in time) the current picture of the current block 1400. The first picture may precede the current picture in terms of a picture order count (POC). The second picture may succeed the current picture in terms of the POC. The reference pictures may both precede or both succeed the current picture in terms of POC. A POC may be/indicate an order in which pictures are output (e.g., from a decoded picture buffer). A POC may be/indicate an order in which pictures are generally intended to be displayed. Pictures that are output may not necessarily be displayed but may undergo different processing and/or consumption (e.g., transcoding). The two reference blocks determined and/or generated using/for bi-prediction may correspond to (e.g., be comprised in) a same reference picture. The reference picture may be included in both the reference picture list 0 and the reference picture list 1, for example, if the two reference blocks correspond to the same reference picture.

A configurable weight and/or offset value may be applied to one or more inter prediction reference blocks. An encoder may enable the use of weighted prediction using a flag in a picture parameter set (PPS). The encoder may send/signal the weight and/or offset parameters in a slice segment header for the current block 1400. Different weight and/or offset parameters may be sent/signaled for luma and/or chroma components.

The encoder may determine and/or generate the reference blocks 1402 and 1404 for the current block 1400 using inter prediction. The encoder may determine a difference between the current block 1400 and each of the reference blocks 1402 and 1404. The differences may be prediction errors or residuals. The encoder may store and/or send/signal, in/via a bitstream, the prediction errors and/or their respective related motion information. The prediction errors and their respective related motion information may be used for decoding and/or other forms of consumption. The motion information for the reference block 1402 may comprise a motion vector 1406 and/or a reference indicator/index. The reference indicator may indicate a reference picture, of the reference block 1402, in a reference picture list. The motion information for the reference block 1402 may comprise an indication of the motion vector 1406 and/or an indication of the reference index. The reference index may indicate the reference picture, of the reference block 1402, in the reference picture list.

The motion information for the reference block 1404 may comprise a motion vector 1408 and/or a reference index/indicator. The reference indicator may indicate a reference picture, of the reference block 1408, in a reference picture list. The motion information for the reference block 1404 may comprise an indication of motion vector 1408 and/or an indication of the reference index. The reference index may indicate the reference picture, of the reference block 1404, in the reference picture list.

A decoder may decode the current block 1400 by determining and/or generating the reference blocks 1402 and 1404. The decoder may determine and/or generate the reference blocks 1402 and 1404, for example, based on the prediction errors and/or the respective related motion information for the reference blocks 1402 and 1404. The reference blocks 1402 and 1404 may correspond to/form (e.g., be considered as) the predictions of the current block 1400. The decoder may decode the current block 1400 based on combining the predictions with the prediction errors.

Motion information may be predictively coded, for example, before being stored and/or sent/signaled in/via a bit stream (e.g., in HEVC, VVC, and/or other video coding standards/formats/protocols). The motion information for a current block may be predictively coded based on motion information of one or more blocks neighboring the current block. The motion information of the neighboring block(s) may often correlate with the motion information of the current block because the motion of an object represented in the current block is often the same as (or similar to) the motion of objects in the neighboring block(s). Motion information prediction techniques may comprise advanced motion vector prediction (AMVP) and/or inter prediction block merging.

An encoder (e.g., the encoder 200 as shown in FIG. 2), may code a motion vector. The encoder may code the motion vector (e.g., using AMVP) as a difference between a motion vector of a current block being coded and a motion vector predictor (MVP). An encoder may determine/select the MVP from a list of candidate MVPs. The candidate MVPs may be/correspond to previously decoded motion vectors of neighboring blocks in the current picture of the current block, and/or blocks at or near the collocated position of the current block in other reference pictures. The encoder and/or a decoder may generate and/or determine the list of candidate MVPs.

The encoder may determine/select an MVP from the list of candidate MVPs. The encoder may send/signal, in/via a bitstream, an indication of the selected MVP and/or a motion vector difference (MVD). The encoder may indicate the selected MVP in the bitstream using an index/indicator. The index may indicate the selected MVP in the list of candidate MVPs. The MVD may be determined/calculated based on a difference between the motion vector of the current block and the selected MVP. For example, for a motion vector that indicates a position (e.g., represented by a horizontal component (MVx) and a vertical component (MVy)) relative to a position of the current block being coded, the MVD may be represented by two components MVD_x and MVD_y. MVD_x and MVD_y may be determined/calculated as:

MVDₓ=MVₓ−MVPₓ (15)

MVD_{y}=MV_{y}−MVP_{y} (16)

MVDx and MVDy may respectively represent horizontal and vertical components of the MVD. MVPx and MVPy may respectively represent horizontal and vertical components of the MVP. A decoder (e.g., the decoder 300 as shown in FIG. 3) may decode the motion vector by adding the MVD to the MVP indicated in/via the bitstream. The decoder may decode the current block by determining and/or generating the reference block. The decoder may determine and/or generate the reference block, for example, based on the decoded motion vector. The reference block may correspond to/form (e.g., be considered as) the prediction of the current block. The decoder may decode the current block by combining the prediction with the prediction error.

The list of candidate MVPs (e.g., in HEVC, VVC, and/or one or more other communication protocols), for AMVP, may comprise two or more candidates (e.g., candidates A and B). Candidates A and B may comprise: up to two (or any other quantity of) spatial candidate MVPs determined/derived from five (or any other quantity of) spatial neighboring blocks of a current block being coded; one (or any other quantity of) temporal candidate MVP determined/derived from two (or any other quantity of) temporal, co-located blocks (e.g., if both of the two spatial candidate MVPs are not available or are identical); and/or zero motion vector candidate MVPs (e.g., if one or both of the spatial candidate MVPs or temporal candidate MVPs are not available). Other quantities of spatial candidate MVPs, spatial neighboring blocks, temporal candidate MVPs, and/or temporal, co-located blocks may be used for the list of candidate MVPs.

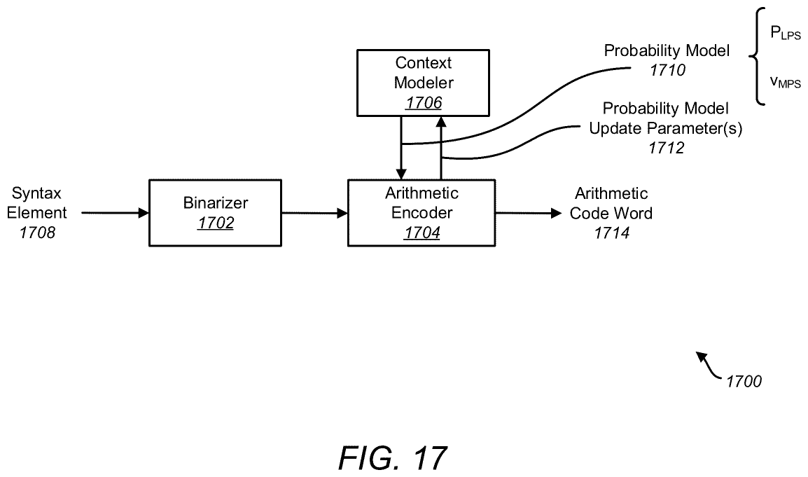

FIG. 15A shows spatial candidate neighboring blocks for a current block. For example, five (or any other quantity of) spatial candidate neighboring blocks may be located relative to a current block 1500 being encoded. The five spatial candidate neighboring blocks may be A0, A1, B0, B1, and B2. FIG. 15B shows temporal, co-located blocks for the current block. For example, two (or any other quantity of) temporal, co-located blocks may be located relative to the current block 1500. The two temporal, co-located blocks may be C0 and C1. The two temporal, co-located blocks may be in one or more reference pictures that may be different from the current picture of the current block 1500.

An encoder (e.g., the encoder 200 as shown in FIG. 2) may code a motion vector using inter prediction block merging (e.g., a merge mode). The encoder (e.g., using merge mode) may reuse the same motion information of a neighboring block (e.g., one of neighboring blocks A0, A1, B0, B1, and B2) for inter prediction of a current block. The encoder (e.g., using merge mode) may reuse the same motion information of a temporal, co-located block (e.g., one of temporal, co-located blocks C0 and C1) for inter prediction of a current block. An MVD need not be sent (e.g., indicated, signaled) for the current block because the same motion information as that of a neighboring block or a temporal, co-located block may be used for the current block (e.g., at the encoder and/or a decoder). A signaling overhead for sending/signaling the motion information of the current block may be reduced because the MVD need not be indicated for the current block. The encoder and/or the decoder may generate a candidate list of motion information from neighboring blocks or temporal, co-located blocks of the current block (e.g., in a manner similar to AMVP). The encoder may determine to use (e.g., inherit) motion information, of one neighboring block or one temporal, co-located block in the candidate list, for predicting motion information of the current block being coded. The encoder may signal/send, in/via a bit stream, an indication of the determined motion information from the candidate list. For example, the encoder may signal/send an indicator/index. The index may indicate the determined motion information in the list of candidate motion information. The encoder may signal/send the index to indicate the determined motion information.

A list of candidate motion information for merge mode (e.g., in HEVC, VVC, or any other coding formats/standards/protocols) may comprise: up to four (or any other quantity of) spatial merge candidates derived/determined from five (or any other quantity of) spatial neighboring blocks (e.g., as shown in FIG. 15A); one (or any other quantity of) temporal merge candidate derived from two (or any other quantity of) temporal, co-located blocks (e.g., as shown in FIG. 15B); and/or additional merge candidates comprising bi-predictive candidates and zero motion vector candidates. The spatial neighboring blocks and the temporal, co-located blocks used for merge mode may be the same as the spatial neighboring blocks and the temporal, co-located blocks used for AMVP.

Inter prediction may be performed in other ways and variants than those described herein. For example, motion information prediction techniques other than AMVP and merge mode may be used. While various examples herein correspond to inter prediction modes, such as used in HEVC and VVC, the methods, devices, and systems as described herein may be applied to/used for other inter prediction modes (e.g., as used for other video coding standards/formats such as VP8, VP9, AV1, etc.). History based motion vector prediction (HMVP), combined intra/inter prediction mode (CIIP), and/or merge mode with motion vector difference (MMVD) (e.g., as described in VVC) may be performed/used and are within the scope of the present disclosure.

Block matching may be used (e.g., in inter prediction) to determine a reference block in a different picture than that of a current block being encoded. Block matching may be used to determine a reference block in a same picture as that of a current block being encoded. The reference block, in a same picture as that of the current block, as determined using block matching may often not accurately predict the current block (e.g., for camera captured videos). Prediction accuracy for screen content videos may not be similarly impacted, for example, if a reference block in the same picture as that of the current block is used for encoding. Screen content videos may comprise, for example, computer generated text, graphics, animation, etc. Screen content videos may comprise (e.g., may often comprise) repeated patterns (e.g., repeated patterns of text and/or graphics) within the same picture. Using a reference block (e.g., as determined using block matching), in a same picture as that of a current block being encoded, may provide efficient compression for screen content videos.

A prediction technique may be used (e.g., in HEVC, VVC, and/or any other coding standards/formats/protocols) to exploit correlation between blocks of samples within a same picture (e.g., of screen content videos). The prediction technique may be intra block copy (IBC) or current picture referencing (CPR). An encoder may apply/use a block matching technique (e.g., similar to inter prediction) to determine a displacement vector (e.g., a block vector (BV)). The BV may indicate a relative position of a reference block (e.g., in accordance with intra block compensated prediction), that best matches the current block, from a position of the current block. For example, the relative position of the reference block may be a relative position of a top-left corner (or any other point/sample) of the reference block. The BV may indicate a relative displacement from the current block to the reference block that best matches the current block. The encoder may determine the best matching reference block from blocks tested during a searching process (e.g., in a manner similar to that used for inter prediction). The encoder may determine that a reference block is the best matching reference block based on one or more cost criteria. The one or more cost criteria may comprise a rate-distortion criterion (e.g., Lagrangian rate-distortion cost). The one or more cost criteria may be based on, for example, one or more differences (e.g., an SSD, an SAD, an SATD, and/or a difference determined based on a hash function) between the prediction samples of the reference block and the original samples of the current block. A reference block may correspond to/comprise prior decoded blocks of samples of the current picture. The reference block may comprise decoded blocks of samples of the current picture prior to being processed by in-loop filtering operations (e.g., deblocking and/or SAO filtering).

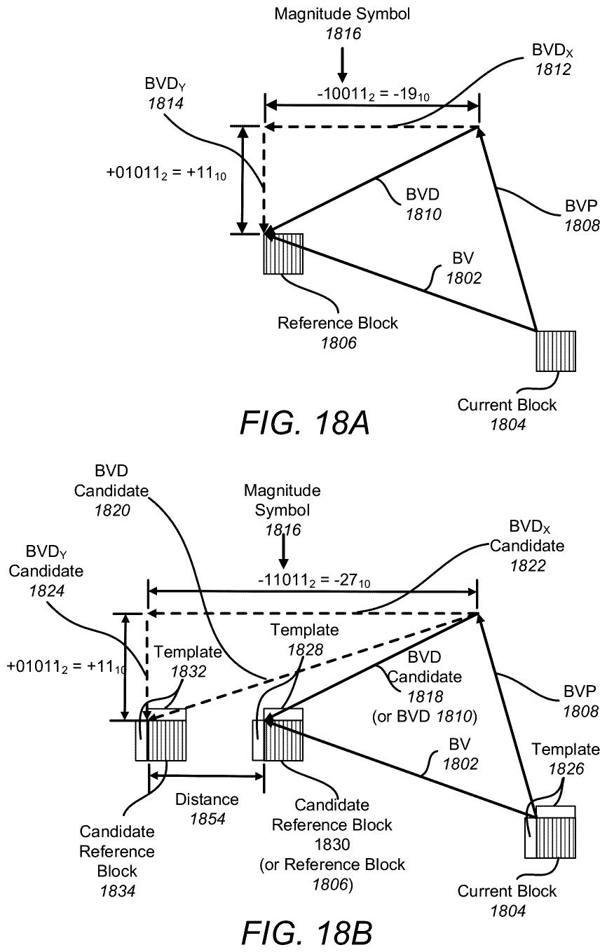

FIG. 16 shows an example of IBC for encoding. The example IBC shown in FIG. 16 may correspond to screen content. The rectangular portions/sections with arrows beginning at their boundaries may be the current blocks being encoded. The rectangular portions/sections that the arrows point to may be the reference blocks for predicting the current blocks.

A reference block may be determined and/or generated, for a current block, for IBC. The encoder may determine a difference (e.g., a corresponding sample-by-sample difference) between the reference block and the current block. The difference may be a prediction error or residual. The encoder may store and/or send/signal, in/via a bitstream the prediction error and/or related prediction information. The prediction error and/or the related prediction information may be used for decoding and/or other forms of consumption. The prediction information may comprise a BV. The prediction information may comprise an indication of the BV. A decoder (e.g., the decoder 300 as shown in FIG. 3), may decode the current block by determining and/or generating the reference block. The decoder may determine and/or generate the current block, for example, based on the prediction information (e.g., the BV). The reference block may correspond to/form (e.g., be considered as) the prediction of the current block. The decoder may decode the current block by combining the prediction with the prediction error.

A BV may be predictively coded (e.g., in HEVC, VVC, and/or any other coding standards/formats/protocols) before being stored and/or sent/signaled in/via a bit stream. The BV for a current block may be predictively coded based on a BV of one or more blocks neighboring the current block. For example, an encoder may predictively code a BV using the merge mode (e.g., in a manner similar to as described herein for inter prediction), AMVP (e.g., as described herein for inter prediction), or a technique similar to AMVP. The technique similar to AMVP may be BV prediction and difference coding (or AMVP for IBC).

An encoder (e.g., the encoder 200 as shown in FIG. 2) performing BV prediction and coding may code a BV as a difference between the BV of a current block being coded and a block vector predictor (BVP). An encoder may select/determine the BVP from a list of candidate BVPs. The candidate BVPs may comprise/correspond to previously decoded BVs of neighboring blocks in the current picture of the current block. The encoder and/or a decoder may generate or determine the list of candidate BVPs.

After the encoder selects a BVP from the list of candidate BVPs, the encoder may signal, in a bitstream, an indication of the selected BVP and a BV difference (BVD). The encoder may indicate the selected BVP in the bitstream by an index pointing into the list of candidate BVPs. The BVD may be calculated based on the difference between the BV of the current block and the selected BVP. For example, for a BV represented by a horizontal component (BVₓ) and a vertical component (BV_{y}) relative to the position of the current block being coded, the BVD may represented by two components calculated as follows:

BVDₓ=BVₓ−BVPₓ (17)

BVD_{y}=BV_{y}−BVP_{y} (18)

where BVDₓ and BVD_{y} respectively represent the horizontal and vertical components of the BVD, and BVPₓ and BVP_{y} respectively represent the horizontal and vertical components of the BVP. A decoder, such as decoder 300 in FIG. 3, may decode the BV by adding the BVD to the BVP indicated in the bitstream. The decoder may then decode the current block by determining and/or generating the reference block, which forms the prediction of the current block, using the decoded BV and combining the prediction with the prediction error.

In HEVC and VVC, the list of candidate BVPs may comprise two candidates referred to as candidates A and B. Candidates A and B may include up to two spatial candidate BVPs derived from five spatial neighboring blocks of the current block being encoded, or one or more of the last two coded BVs when spatial neighboring candidates are not available (e.g., because they are coded in intra or inter mode). The location of the five spatial candidate neighboring blocks relative to a current block being encoded using IBC are the same as those shown in FIG. 15A for inter prediction. The five spatial candidate neighboring blocks are respectively denoted A₀, A₁, B₀, B₁, and B₂.

Entropy coding may be performed at an end of a video encoding process and/or at a beginning of a video decoding process (e.g., as described herein with respect to FIGS. 2 and 3). Entropy coding is a technique for compressing a sequence of symbols by representing symbols with greater probability of occurring using fewer bits than symbols with less probability of occurring. Shannon's information theory provides that the optimal average code length for a symbol with probability p is −log₂p, for example, if the compressed sequence of symbols is represented in bits {0, 1}.

Arithmetic coding is a method of entropy coding that may be based on recursive interval subdivision. An initial coding interval may be divided into m disjoint subintervals, for example, to arithmetically encode a symbol that takes a value from an m-ary source alphabet. Each of the m disjoint subintervals may have a width proportional to a probability of the symbol having a different one of the values in the m-ary source alphabet. The probabilities of the symbol having the different values in the m-ary source alphabet may be referred to as a probability model for the symbol. A symbol may be arithmetically encoded by choosing a subinterval corresponding to an actual value of the symbol as the new coding interval. By recursively using this interval-subdivision scheme to each symbol sᵢ of a given sequence s={s₁, s₂, . . . , s_{N}), the encoder may determine a value in the range of the final coding interval as the arithmetic code word for the sequence s. By recursively using this interval-subdivision scheme to each symbol s₁ of a given sequence s={s₁, s₂, . . . , s_{N}), the encoder may determine a value in the range of the final coding interval, for example, after the Nth interval subdivision, as the arithmetic code word for the sequence s. Each successive symbol of a sequence s that is encoded may reduce the size of the coding interval in accordance with the probability model of the symbol. The more likely symbol values reduce the size of the coding interval by less than the unlikely symbol values and thus add fewer bits to the arithmetic code word for the sequence s in accordance with the general principle of entropy coding.

Arithmetic decoding may be based on the same recursive interval subdivision. To arithmetically decode a symbol that takes a value from an m-ary source alphabet, an initial coding interval may be divided into m disjoint subintervals. Each of the m disjoint subintervals may have a width proportional to the probability of the symbol having a different one of the values in the m-ary source alphabet. The probabilities of the symbol having the different values in the m-ary source alphabet may be referred to as a probability model for the symbol, as mentioned herein. The symbol may be arithmetically decoded from an arithmetic code word by determining the symbol value corresponding to the subinterval in which the arithmetic code word falls within. This subinterval then may become the new coding interval. A decoder may sequentially decode each symbol s₁ of a sequence s={s₁, s₂, . . . , s_{N}) by recursively using this interval-subdivision scheme N times and determining which subinterval the arithmetic code word falls within each iteration.

A different probability model may be used to subdivide a coding interval for each symbol arithmetically coded. A probability model for a symbol may be determined, for example, by a fixed selection (e.g., based on a position of the symbol in a sequence of symbols) and/or by an adaptive selection from among two or more probability models (e.g., based on information related to the symbol). Two or more symbols in a sequence of symbols may use a joint probability model. Selection of a probability model for a symbol may be referred to as context modeling. Arithmetic coding that employs context modeling may be referred to as context-based arithmetic coding. A selected probability model may be updated based on an actual coded value of a symbol, for example, in addition to a probability model selection for a symbol. The probability of the actual coded value of the symbol may, for example, be increased in the probability model and the probability of all other values may be decreased. Arithmetic coding that employs both context modeling and probability model adaptation may be referred to as context-based adaptive arithmetic coding.

Other variations of arithmetic coding may be possible. If arithmetic coding occurs, a renormalization operation may be performed, for example, to ensure that the precision needed to represent the range and lower bound of a subinterval does not exceed the finite precision of registers used to store these values. Other simplifications to the coding process may additionally be made to decrease complexity, increase speed, and/or reduce power requirements of the implementation of the coding process in either hardware, software, or some combination of the two. Probabilities of symbols and lower bounds and ranges of subintervals, for example, may be approximated or quantized in such implementations.

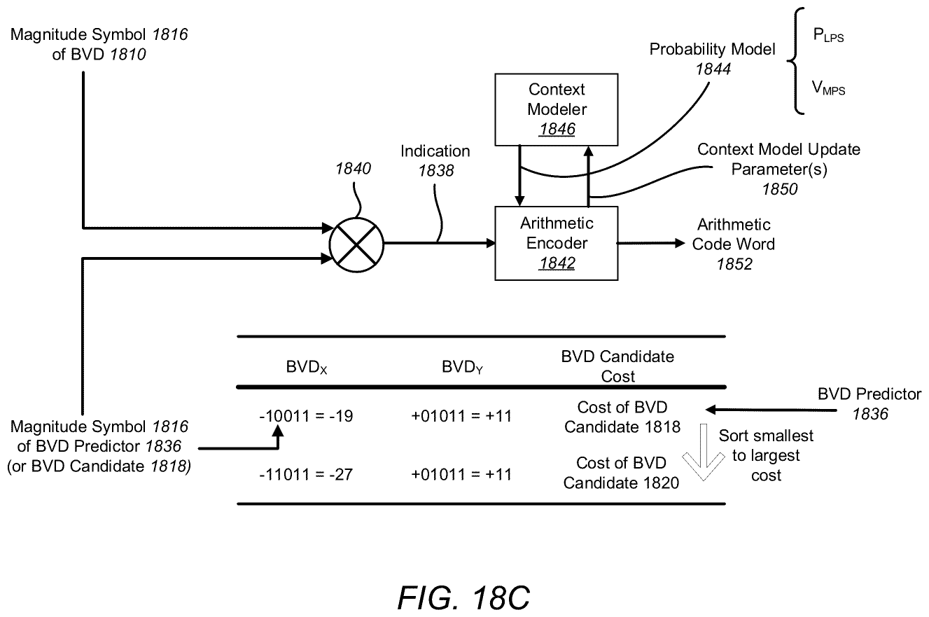

FIG. 17 shows an example of a context-based adaptive binary arithmetic coding (CABAC) encoder. A CABAC encoder (e.g., CABAC encoder 1700) may be implemented in a video encoder for entropy encoding syntax elements of a video sequence, such as a video encoder 200 as described herein with respect to FIG. 2. As shown in FIG. 17, a CABAC encoder (e.g., CABAC encoder 1700) may comprise a binarizer 1702, an arithmetic encoder 1704, and/or a context modeler 1706.

A CABAC encoder (e.g., CABAC encoder 1700) may receive a syntax element 1708 for arithmetic encoding. Syntax elements (e.g., syntax element 1708) may be generated at a video encoder and/or may describe how a video signal may be reconstructed at a video decoder. Syntax elements may comprise an intra prediction mode based on a coding unit (CU) being intra predicted. Syntax elements may comprise motion data (e.g., MVD and MVP related data) based on the CU being inter predicted. Syntax elements may comprise displacement data (e.g., BVD and BVP related data) based on the CU being predicted using IBC.

A binarizer (e.g., binarizer 1702) may map a value of a syntax element (e.g., syntax element 1708) to a sequence of binary symbols (e.g., bins). The binarizer 1702 may define a unique mapping of values of syntax element 1708 to sequences of binary symbols. Binarization of syntax elements may help to improve probability modeling and implementation of arithmetic encoding. The binarizer 1702 may implement one or more binarization processes (e.g., unary, truncated unary, k-th order truncated Rice, k-th order exponential-Golomb (EGk), fixed-length, or some combination of two or more of these binarization processes). The binarizer 1702 may select a binarization process. The binarizer 1702 may select a binarization process, for example, based on a type of syntax element 1708 and/or on one or more syntax elements processed by CABAC encoder 1700 before syntax element 1708. The binarizer 1702 may not process a syntax element 1708. The binarizer 1702 may not process a syntax element 1708, for example, based on syntax element 1708 already being represented by a sequence of one or more binary symbols. A binarizer 1702 may not be used and a syntax element 1708 may be directly encoded by CABAC encoder 1700, for example, if represented by a sequence of one or more non-binary symbols.

One or more of the binary symbols may be processed by an arithmetic encoder (e.g., arithmetic encoder 1704). One or more of the binary symbols may be processed by an arithmetic encoder 1704, for example, based on (e.g., after) the binarizer 1702 optionally maps the value of syntax element 1708 to a sequence of binary symbols. The arithmetic encoder 1704 may process each of the one or more binary symbols in one of at least two modes: regular arithmetic encoding mode or bypass arithmetic encoding mode.

An arithmetic encoder (e.g., arithmetic encoder 1704) may process binary symbols that do not have a uniform, or approximately uniform, probability distribution in regular arithmetic encoding mode (e.g., binary symbols that do not have a probability distribution of 0.5 for each of their two possible values). In a regular arithmetic encoding mode, the arithmetic encoder 1704 may perform arithmetic encoding as described herein. The arithmetic encoder 1704 may, for example, subdivide a current coding interval into m disjoint subintervals. Each of the m disjoint subintervals may have a width proportional to a probability of the binary symbol having a different one of the values in an m-ary source alphabet. For example, with respect to a binary symbol, the value of m may be equal to two and the current coding interval may be subdivided into two disjoint intervals that each have a width proportional to the probability of a different one of the two possible values {0, 1} for the binary symbol being encoded. The probabilities of the two possible values for the binary symbol may be indicated by a probability model (e.g., probability model 1710) for the binary symbol. The arithmetic encoder 1704 may encode the binary symbol by choosing a subinterval corresponding to an actual value of the binary symbol as a new coding interval for the next binary symbol to be encoded.

An arithmetic encoder (e.g., arithmetic encoder 1704) may receive a probability model 1710 from a context modeler (e.g., context modeler 1706). The context modeler 1706 may determine the probability model 1710 for the binary symbol by a fixed selection. The context modeler 1706 may determine the probability model 1710 for the binary symbol by a fixed selection, for example, based on a position of the binary symbol in the sequence of binary symbols representing syntax element 1708. The context modeler 1706 may determine the probability model 1710 for the binary symbol by an adaptive selection from among two or more probability models. The context modeler 1706 may determine the probability model 1710 for the binary symbol by an adaptive selection from among two or more probability models, for example, based on information related to the binary symbol. As shown in FIG. 17, a probability model (e.g., probability model 1710) may comprise two parameters: a probability P_{LPS} of the least probable symbol (LPS) and the value V_{MPS} of the most probable symbol (MPS). A probability model 1710 may comprise a probability P_{MPS} of the MPS in addition or alternatively to the probability P_{LPS} of the LPS. Similarly, a probability model (e.g., probability model 1710) may comprise a value V_{LPS} of a LPS in addition or alternatively to a value V_{MPS} of a MPS. An arithmetic encoder (e.g., arithmetic encoder 1704) may provide one or more probability model update parameters (e.g., probability model update parameters 1712) to a context modeler (e.g., context modeler 1706). The arithmetic encoder 1704 may provide one or more probability model update parameters 1712 to a context modeler 1706, for example, after arithmetic encoder 1704 encodes the binary symbol. The context modeler 1706 may adapt probability model 1710. The context modeler 1706 may adapt probability model 1710, for example, based on the one or more probability model update parameters 1712. The one or more probability model update parameters 1712 may comprise an actual coded value of a binary symbol. A context modeler 1706 may update a probability model 1710 by increasing P_{LPS} if the actual coded value of the binary symbol is not equal to V_{MPS} and by decreasing P_{LPS} otherwise.

An arithmetic encoder (e.g., arithmetic encoder 1704) may process binary symbols that may have a uniform, or an approximately uniform, probability distribution in bypass arithmetic encoding mode. An arithmetic encoder 1704 may bypass a probability model determination and/or adaptation performed in regular arithmetic encoding mode if encoding these binary symbols to speed up the encoding process, for example, because binary symbols processed by the arithmetic encoder 1704 in bypass arithmetic encoding mode may have a uniform, or approximately uniform, probability distribution. Additionally, subdivision of the current coding interval may be simplified due to the uniform, or approximately uniform, probability distribution. The current coding interval, for example, may be partitioned into two disjoint subintervals of equal width, which may be realized using a simple implementation that may further speed up the encoding process. An arithmetic encoder (e.g., arithmetic encoder 1704) may encode a binary symbol by choosing a subinterval corresponding to a value of a binary symbol as the new coding interval for the next binary symbol to be encoded. The resulting increase in encoding speed for binary symbols encoded by arithmetic encoder 1704 in bypass arithmetic encoding mode may be important because CABAC encoding may have throughput limitations.

An arithmetic encoder (e.g., arithmetic encoder 1704) may determine a value in the range of the final coding interval as an arithmetic code word (e.g., arithmetic code word 1714) for the binary symbols. An arithmetic encoder 1704 may determine a value in the range of the final coding interval as an arithmetic code word 1714 for the binary symbols, for example based on processing a number of binary symbols (e.g., corresponding to one or more syntax elements). The arithmetic encoder 1704 may output an arithmetic code word 1714. The arithmetic encoder 1704 may output the arithmetic code word 1714 to a bitstream that may be received and processed by a video decoder.

Two syntax elements that may be coded in bypass arithmetic coding mode are a magnitude of a motion vector difference (MVD) and a magnitude of a block vector difference (BVD). The MVD and BVD syntax elements may be respectively determined as part of advanced motion vector prediction (AMVP) for inter prediction and AMVP for intra block copy (IBC) as described herein. Although bypass arithmetic coding mode may be used to speed up an arithmetic coding process, compression of the symbols of the MVD and BVD syntax elements coded in bypass arithmetic encoding mode may be limited because their probability distributions are presumed to be uniformly distributed. From information theory, a symbol cannot be compressed at a rate less than its entropy without loss of information, and a symbol with a uniform probability distribution has maximum entropy. Thus, symbols coded using the bypass arithmetic encoding mode may generally require more bits to encode than symbols encoded using the regular arithmetic encoding mode.

Improvements described herein include advantages such as improving the compression efficiency of one or more magnitude symbols of a BVD. Instead of entropy coding a magnitude symbol of the BVD, entropy coding of an indication of whether a value of the magnitude symbol of the BVD matches a value of the magnitude symbol of a BVD candidate used as a predictor of the BVD may be performed. The BVD predictor may be selected from among a plurality of BVD candidates, for example, based on costs of the plurality of BVD candidates. The cost of each BVD candidate in the plurality of BVD candidates may be calculated, for example, based on a difference between a template of a current block and a template of a candidate reference block. The candidate reference block may be displaced relative to the current block by a sum of the BVD candidate and a block vector predictor (BVP). The indication of whether the value of the magnitude symbol of the BVD matches the value of the magnitude symbol of the BVD predictor may have a non-uniform probability distribution, thereby providing improved compression efficiency over coding the magnitude symbol of the BVD based on a uniform probability distribution.

Improvements described herein further include advantages such as improving the compression efficiency of one or more magnitude symbols of a MVD Instead of entropy coding a magnitude symbol of the MVD, entropy coding of an indication of whether a value of a magnitude symbol of a MVD matches a value of a magnitude symbol of an MVD candidate used as a predictor of the MVD may be performed. A MVD predictor may be selected from among a plurality of MVD candidates, for example, based on costs of the plurality of MVD candidates. The cost of each MVD candidate in the plurality of MVD candidates may be calculated, for example, based on a difference between a template of a current block and/or a template of a candidate reference block. The candidate reference block may be displaced relative to a co-location of the current block in a reference frame by a sum of the cost of the MVD candidate and/or a motion vector predictor (MVP). An indication of whether the value of the magnitude symbol of the MVD matches the value of the magnitude symbol of the MVD predictor may have a non-uniform probability distribution, thereby providing improved compression efficiency over coding the magnitude symbol of the MVD based on a uniform probability distribution.

Both HEVC and VVC include a prediction technique to exploit a correlation between blocks of samples within a same picture, for example, as described herein. The prediction technique may be referred to as intra block code (IBC). IBC is also included in the Enhanced Compression Model (ECM) software algorithm that is currently under coordinated exploration study by the Joint Video Exploration Team (JVET) of ITU-T Video Coding Experts Group (VCEG) and ISO/IEC MPEG as a potential enhanced video coding technology beyond the capabilities of VVC.

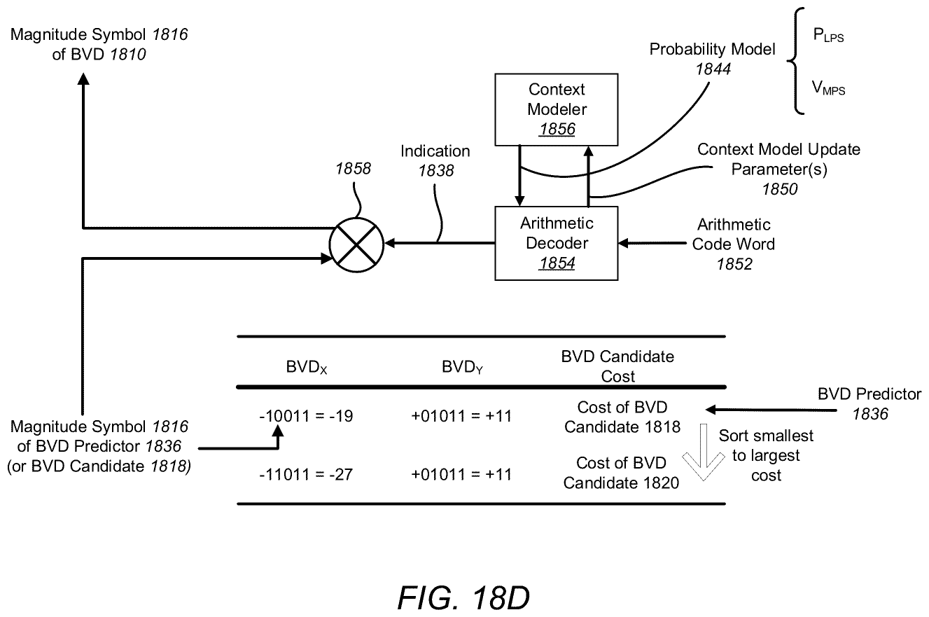

FIG. 18A shows an example of IBC. If IBC occurs, an encoder may determine a block vector (BV) 1802 that may indicate a displacement from a current block 1804 to a reference block or an intra block compensated prediction 1806. The encoder may determine the reference block 1806 from among one or more reference blocks tested during a searching process. The encoder may determine a difference (e.g., sum of squared differences (SSD), sum of absolute differences (SAD), sum of absolute transformed differences (SATD), and/or difference determined based on a hash function) between the samples of the reference block and the samples of current block 1804, for example, for each of the one or more reference blocks tested during a searching process. The encoder may determine a reference block 1806 from among the one or more reference blocks based on a reference block 1806 having the smallest difference from a current block 1804 among the one or more reference blocks and/or based on some other criteria. Reference block 1806 and/or the one or more other reference blocks tested during the searching process may comprise decoded and/or reconstructed samples. The decoded and/or reconstructed samples may not have been processed by in-loop filtering operations (e.g., deblocking and/or SAO filtering).

An encoder may use a reference block 1806 to predict a current block 1804. An encoder may use a reference block 1806 to predict a current block 1804, for example, if the reference block 1806 is determined for current block 1804. The encoder may determine and/or use a difference (e.g., a corresponding sample-by-sample difference) between reference block 1806 and current block 1804. The difference may be referred to as a prediction error or residual. The encoder may signal the prediction error and/or the related prediction information in a bitstream. Prediction information may include BV 1802. Prediction information may include an indication of BV 1802. A decoder (e.g., a decoder as described herein with respect to FIG. 3) may receive a bitstream and/or decode a current block 1804 by determining a reference block 1806, which may form a prediction of current block 1804, using the prediction information and/or combining the prediction with the prediction error.

A BV (e.g., BV 1802) may be predictively encoded. A BV (e.g., BV 1802) may be predictively encoded, for example, before being signaled in a bit stream. A BV (e.g., BV 1802) may be predictively encoded, for example, based on the BVs of neighboring blocks of current block 1804 or BVs of other blocks. An encoder may predictively encode BV 1802, for example, using the merge mode or AMVP as described herein. The encoder may encode BV 1802 as a difference between BV 1802 and a BV predictor (BVP) 1808 for AMVP, as shown in FIG. 18A. The encoder may select BVP 1808 from a list of candidate BVPs. The candidate BVPs may come from previously decoded BVs of neighboring blocks of current block 1804 or other sources. Both the encoder and decoder may generate or determine the list of candidate BVPs.

An encoder may signal, in a bitstream, an indication of a BVP (e.g., BVP 1808) and a BV difference (e.g., BVD 1810). An encoder may signal, in a bitstream, an indication of BVP 1808 and BVD 1810, for example, based on the encoder selecting BVP 1808 from the list of candidate BVPs. The encoder may indicate BVP 1808 in the bitstream by an index, pointing into the list of candidate BVPs, and/or one or more flags. BVD 1810 may be calculated based on the difference between BV 1802 and BVP 1808. BVD 1810 may comprise a horizontal component (BVDₓ) 1812 and a vertical component (BVD_{y}) 1814 that may be respectively determined in accordance with Equations (17) and (18) above. The two components BVDₓ 1812 and BVD_{y} 1814 each comprise a magnitude and sign. As shown in FIG. 18A, BVDₓ 1812 has a magnitude of 10011 in fixed length binary (or 19 in base 10) and a negative sign. A positive horizontal direction points to the right in the example shown in FIG. 18A. As further shown in FIG. 18A, BVD_{y} 1814 has a magnitude of 01011 in fixed length binary (or 11 in base 10) and a positive sign. A positive vertical direction points down in the example shown in FIG. 18A. The encoder may indicate BVD 1810 in the bitstream via its two components BVDₓ 1812 and BVD_{y} 1814.

The decoder may decode a BV (e.g., BV 1802) by adding BVD 1810 to BVP 1808. The decoder may decode a current block (e.g., current block 1804) by determining a reference block (e.g., reference block 1806), which forms the prediction of current block 1804, using BV 1802 and combining the prediction with the prediction error. The decoder may determine reference block 1806 by adding BV 1802 to the location of current block 1804, which may give the location of reference block 1806.

As described herein, a magnitude of a BVD (e.g., BVD 1810) may be encoded in bypass arithmetic encoding mode. Although the bypass arithmetic encoding mode may be used to speed up the arithmetic encoding process, compression of the magnitude symbols of BVD 1810 encoded in bypass arithmetic encoding mode may be limited because their probability distributions may be uniformly distributed, or nearly uniformly distributed. From information theory, a symbol cannot be compressed at a rate less than its entropy without loss of information, and a symbol with uniform probability distribution has maximum entropy. Thus, symbols encoded using the bypass arithmetic encoding mode may generally require more bits to encode than symbols encoded using the regular arithmetic encoding mode.

As described herein the compression efficiency of one or more magnitude symbols of a BVD (e.g., BVD 1810) may be improved. An encoder may entropy encode an indication of whether a value of the magnitude symbol of BVD 1810 matches a value of the same magnitude symbol of a BVD candidate used as a predictor of BVD 1810 or not. An encoder may entropy encode this indication, for example, instead of directly entropy encoding a magnitude symbol of BVD 1810. The indication of whether the value of the magnitude symbol of BVD 1810 matches the value of the magnitude symbol of the BVD predictor may have a non-uniform probability distribution and therefore may provide improved compression efficiency. The encoder may select the BVD predictor from among a plurality of BVD candidates. The encoder may select the BVD predictor from among a plurality of BVD candidates, for example, based on costs of the plurality of the BVD candidates. The BVD candidates may include a BVD candidate for each possible value of the magnitude symbol of BVD 1810. A magnitude symbol of BVD 1810 that may be represented in binary form has only two possible values. Therefore, the BVD candidates may include two BVD candidates for this representation, one for each possible value of the magnitude symbol in BVD 1810 being encoded: a first BVD candidate equal to the BVD 1810 itself and a second BVD candidate equal to BVD 1810 but with the opposite (or other) value of the magnitude symbol of BVD 1810. A cost for each BVD candidate in the plurality of BVD candidates may be calculated, for example, based on a difference between a template of current block 1804 and a template of a candidate reference block. The candidate reference block may be displaced relative to the current block by a sum of the BVD candidate and BVP 1808.

FIG. 18A shows an example magnitude symbol 1816 of BVD 1810 to be entropy encoded. Magnitude symbol 1816 of BVD 1810 may be the second most significant bit in the fixed length binary representation of horizontal component BVDₓ 1812 of BVD 1810 and may have a binary value of “0”. As described herein, the encoder may entropy encode an indication of whether the value of magnitude symbol 1816 of BVD 1810 matches the value of the same magnitude symbol of a BVD candidate used as a predictor of BVD 1810, for example, instead of directly entropy encoding magnitude symbol 1816 of BVD 1810. The encoder may select the BVD predictor from among a plurality of BVD candidates, for example, based on costs of the plurality of BVD candidates. The BVD candidates may include a BVD candidate for each of the two possible values {0, 1} of magnitude symbol 1816 of BVD 1810: a first BVD candidate 1818 equal to BVD 1810 itself and a second BVD candidate 1820 equal to BVD 1810 but with the opposite (or other) value of magnitude symbol 1816 of BVD 1810.

FIG. 18B shows example BVD candidates for entropy encoding a magnitude symbol 1816 of a BVD 1810. Specifically, FIG. 18B shows an example BVD candidate 1818 equal to BVD 1810 itself and BVD candidate 1820 equal to the BVD 1810 but with the opposite (or other) value of magnitude symbol 1816 of BVD 1810. With the opposite (or other) value of magnitude symbol 1816 of BVD candidate 1818, BVD candidate 1820 has a horizontal component BVDₓ 1822 with a magnitude of 11011 in fixed length binary (or 27 in base 10) and a negative sign. The vertical component BVD_{y} 1824 of BVD candidate 1820 has the same magnitude of 01011 in fixed length binary (or 11 in base 10) and positive sign as vertical component BVD_{y} 1814 of BVD candidate 1818 (or BVD 1810).

The cost for each BVD candidate in the plurality of BVD candidates may be calculated, for example, based on a difference between a template of current block 1826 and a template of a candidate reference block displaced relative to current block 1804 by a sum of the BVD candidate and BVP 1808. An encoder may determine a cost for BVD candidate 1818, for example, based on a difference between a template 1826 of current block 1804 and a template 1828 of a candidate reference block 1830 displaced relative to current block 1804 by a sum of BVD candidate 1818 and BVP 1808. The encoder may determine the difference between template 1826 and template 1828, for example, based on a difference between samples of template 1826 and samples of template 1828. This difference may comprise, for example, a sum of squared differences (SSD), a sum of absolute differences (SAD), a sum of absolute transformed differences (SATD), a mean removal SAD, and/or a mean removal SSD. The encoder may determine a cost for BVD candidate 1820, for example, based on a difference between template 1826 of current block 1804 and a template 1832 of a candidate reference block 1834 displaced relative to current block 1804 by a sum of BVD candidate 1820 and BVP 1808. The encoder may determine the difference between template 1826 and template 1832, for example, based on a difference (e.g., SSD, SAD, SATD, mean removal SAD, or mean removal SSD) between samples of template 1826 and samples of template 1828. Templates 1826, 1828, and 1832 may comprise one or more samples to the left and/or above their respective blocks. Templates 1826, 1828, and 1832 may comprise samples from one or more columns to the left of their respective block and/or from one or more rows above their respective block. FIG. 18B shows one example position and shape (e.g., L-shape rotated clockwise 90 degrees) of templates 1826, 1828, and 1832.

An encoder may select one of a plurality of BVD candidates as a BVD predictor. An encoder may select one of a plurality of BVD candidates as a BVD predictor, for example, based on determining the costs of each of the plurality of BVD candidates. The encoder may select the BVD candidate that may have the smallest cost among the plurality of BVD candidates as the BVD predictor. FIG. 18C shows an example table with components and costs of BVD candidates. The BVD candidates 1818 and 1820 may be assumed to be the only BVD candidates. More BVD candidates may be used. The rows of the table may be sorted by the costs of BVD candidates 1818 and 1820, with the BVD candidate with the smallest cost on top. BVD candidate 1818 may have the smallest cost among BVD candidates 1818 and 1820. The encoder may select BVD candidate 1818 as the BVD predictor 1836 for BVD 1810, for example, because BVD candidate 1818 has the smallest cost among BVD candidates 1818 and 1820.

An encoder may entropy encode an indication (e.g., indication 1838) of whether the value of magnitude symbol 1816 of BVD 1810 matches the value of magnitude symbol 1816 in BVD predictor 1836. An encoder may entropy encode an indication 1838 of whether the value of magnitude symbol 1816 of BVD 1810 matches the value of magnitude symbol 1816 in BVD predictor 1836, for example, based on selecting BVD candidate 1818 as BVD predictor 1836. A magnitude symbol 1816 of a BVD predictor (e.g., BVD predictor 1836) may have a value of “0”, which matches the value of magnitude symbol 1816 of BVD 1810. An indication 1838 may indicate that a value of magnitude symbol 1816 of BVD 1810 matches the value of magnitude symbol 1816 of BVD predictor 1836. An indication (e.g., indication 1838) may be a single bit that has the value “0” if the value of magnitude symbol 1816 of BVD 1810 matches the value of magnitude symbol 1816 of BVD predictor 1836. An indication (e.g., indication 1838) may be a single bit that has the value “1” if the value of magnitude symbol 1816 of BVD 1810 does not match the value of magnitude symbol 1816 of BVD predictor 1836. Logic (e.g., logic 1840) may be used to determine indication 1838. The logic 1840 may implement a logical exclusive (XOR) function. The indication 1838 may indicate a first candidate among a plurality of candidates (e.g., as sorted based on their respective costs) may have a value of magnitude symbol 1816 that matches the value of magnitude symbols 1816 in BVD 1810, for example, if a magnitude symbol 1816 is non-binary.

In FIG. 18C, an encoder may entropy encode indication 1838 using an arithmetic encoder (e.g., arithmetic encoder 1842). An indication 1838 may have a non-uniform probability distribution, for example, based on a method of determining an indication (e.g., indication 1838) as described herein. Therefore, an arithmetic encoder 1842 may process indication 1838 in regular arithmetic encoding mode as described herein. The arithmetic encoder 1842 may subdivide a current coding interval into m disjoint subintervals. Each of the m disjoint subintervals may have a width proportional to the probability of the symbol being encoded having a different one of the values in an m-ary source alphabet. For the indication 1838, which is binary, a value of m may be equal to two and the current coding interval may be subdivided into two disjoint intervals that each have a width proportional to the probability of a different one of the two possible values {0, 1} for indication 1838 being encoded. The probabilities of the two possible values for indication 1838 may be indicated by a probability model 1844 for indication 1838. The arithmetic encoder 1842 may encode indication 1838 by choosing the subinterval corresponding to the actual value of indication 1838 as the new coding interval for the next binary symbol to be encoded.

An arithmetic encoder (e.g., arithmetic encoder 1842) may receive a probability model (e.g., probability model 1844) from a context modeler (e.g., context modeler 1846). The context modeler 1846 may determine probability model 1844 for an indication (e.g., indication 1838) by a fixed selection or an adaptive selection from among two or more probability models. The context modeler 1846 may determine probability model 1844 by a fixed selection or an adaptive selection from among two or more probability models, for example, based on a position of magnitude symbol 1816 in BVDₓ 1812 of BVD 1810 or an index of (e.g., a value indicating) the position of magnitude symbol 1816 in BVDₓ 1812 of BVD 1810. The position (e.g., an index of the position) of magnitude symbol 1816 in BVDₓ 1812 of BVD 1810 may provide an indication of the distance 1853 (as described herein with respect to FIG. 18B) between the two candidate BVDs. The likelihood of the value of magnitude symbol 1816 of BVD predictor 1836 matching the value of magnitude symbol 1816 of BVD 1810 may be related to distance 1853. More particularly, the extent of the difference between respective templates of the candidate BVDs may likely be larger for greater values of distance 1853 between the candidate BVDs. The larger the difference between respective templates of the BVD candidates, the more likely the costs of the BVD candidates accurately reflect the BVD candidate with a value of magnitude symbol 1816 that matches the value of magnitude symbol 1816 of BVD 1810. The position (e.g., index of the position) of magnitude symbol 1816 in BVDₓ 1812 of BVD 1810 may be helpful in selecting probability model 1844 for indication 1838.

A context modeler 1846 may compare a position and/or an index of a position of the magnitude symbol 1816, also referred to herein as a significance of the magnitude symbol 1816, in BVDₓ 1812 of BVD 1810 to one or more thresholds for adaptive selection from among two or more probability models. The context modeler 1846 may compare the position and/or index of the position of the magnitude symbol 1816 in BVDₓ 1812 of BVD 1810 to a first threshold. The context modeler 1846 may select a first probability model for an indication 1838, for example, based on the position and/or the index of the position of magnitude symbol 1816 in BVDₓ 1812 of BVD 1810 being less than a threshold. The context modeler 1846 may select a second probability model for indication 1838, for example, based on the position and/or index of the position of magnitude symbol 1816 in BVDₓ 1812 of BVD 1810 being greater than the threshold. A context modeler 1846 may compare the position and/or index of the position of magnitude symbol 1816 in BVDₓ 1812 of BVD 1810 to a second threshold, for example, based on a position and/or an index of the position of a magnitude symbol 1816 in BVDₓ 1812 of BVD 1810 being greater than a threshold. The context modeler 1846 may select a second probability model for indication 1838, for example, based on the position and/or the index of the position of magnitude symbol 1816 in BVDₓ 1812 of BVD 1810 being less than the second threshold. The context modeler 1846 may select a third probability model for indication 1838, for example, based on the position and/or index of the position of magnitude symbol 1816 in BVDₓ 1812 of BVD 1810 being greater than the second threshold.

A context modeler 1846 may determine a probability model 1844 by a fixed selection and/or an adaptive selection from among two or more probability models, for example based on a change in a value of a BVD 1810 and/or a BVDx 1812 of the BVD 1810 for an incremental change in value of a magnitude symbol 1816 of BVD 1810, also referred to herein as a significance of the magnitude symbol 1816. A change in value of the BVD 1810 and/or the BVDx 1812 of the BVD 1810 for an incremental change in value of the magnitude symbol 1816 of the BVD 1810 may be determined as 2⁽ⁿ⁻¹⁾, where n is a bit position of the magnitude symbol 1816 in the BVDx 1812 of the BVD 1810. A change in value of the BVD 1810 and/or the BVDx 1812 of the BVD 1810 for an incremental change in value of magnitude symbol 1816 of BVD 1810 may be determined as 2⁽⁴⁻¹⁾ or 8, for example, if n=4. The change in value of the BVD 1810 and/or the BVDx 1812 of the BVD 1810 for an incremental change in the value of a magnitude symbol 1816 of the BVD 1810 may provide an indication of a distance 1854 (e.g., as described herein with respect to FIG. 18B) between the two candidate BVDs.

As described herein, the probability of the value of a magnitude symbol 1816 of a BVD predictor 1836 matching the value of a magnitude symbol 1816 of a BVD 1810 may be related to the distance 1854. More particularly, an extent of the difference between respective templates of candidate BVDs is likely to be larger for greater values of a distance 1854 between the candidate BVDs. The larger the difference between respective templates of the BVD candidates, the more likely the costs of the BVD candidates may accurately reflect the BVD candidate with a value of magnitude symbol 1816 that matches the value of magnitude symbol 1816 of BVD 1810. Thus, a change in a value of a BVD 1810 and/or a BVDx 1812 of the BVD 1810 for an incremental change in value of magnitude symbol 1816 of BVD 1810 may be helpful in selecting a probability model 1844 for an indication 1838.

A context modeler 1846 may compare a value of a BVD 1810 and/or a BVDx 1812 of the BVD 1810 for an incremental change in a value of a magnitude symbol 1816 of the BVD 1810 to one or more thresholds, for adaptive selection from among two or more probability models. The context modeler 1846 may compare the value of the BVD 1810 and/or the BVDx 1812 of the BVD 1810 for an incremental change in the value of the magnitude symbol 1816 of the BVD 1810 to a first threshold. The context modeler 1846 may select a first probability model for an indication 1838, for example, based on the value of the BVD 1810 and/or the BVDx 1812 of the BVD 1810 for an incremental change in the value of the magnitude symbol 1816 of the BVD 1810 being less than a threshold. A context modeler 1846 may select a second probability model for an indication 1838, for example, based on a value of BVD 1810 and/or a BVDx 1812 of the BVD 1810 for an incremental change in a value of a magnitude symbol 1816 of the BVD 1810 being greater than a threshold. A context modeler 1846 may compare a value of a BVD 1810 and/or a BVDx 1812 of the BVD 1810 for an incremental change in a value of a magnitude symbol 1816 of the BVD 1810 to a second threshold, for example, based on the value of the BVD 1810 and/or the BVDx 1812 of the BVD 1810 for an incremental change in a value of a magnitude symbol 1816 of the BVD 1810 being greater than a threshold. A context modeler 1846 may select a second probability model for an indication 1838, for example, based on a value of a BVD 1810 and/or a BVDx 1812 of the BVD 1810 for an incremental change in a value of a magnitude symbol 1816 of the BVD 1810 being less than the second threshold. A context modeler 1846 may select a third probability model for an indication 1838, for example, based on a value of a BVD 1810 and/or a BVDx 1812 of the BVD 1810 for an incremental change in a value of a magnitude symbol 1816 of the BVD 1810 being greater than the second threshold.

As shown in FIG. 18C, a probability model (e.g., probability model 1844) may comprise two parameters: a probability P_{LPS} of a least probable symbol (LPS) for indication 1838 and a value V_{MPS} of a most probable symbol (MPS) for indication 1838. A probability model 1844 may comprise the probability P_{MPS} of the MPS for indication 1838 in addition, or alternatively, to the probability P_{LPS} of the LPS for indication 1838. Similarly, a probability model (e.g., probability model 1844) may comprise the value V_{LPS} of the LPS for indication 1838 in addition, or alternatively, to the value V_{MPS} of the MPS for indication 1838. The arithmetic encoder 1842 may provide one or more probability model update parameters 1850 to a context modeler 1846. The arithmetic encoder 1842 may provide one or more probability model update parameters 1850 to a context modeler 1846, for example, based on an arithmetic encoder 1842 encoding indication 1838. The context modeler 1846 may adapt a probability model 1844 based on the one or more probability model update parameters 1850. The one or more probability model update parameters 1850 may comprise the actual coded value of indication 1838. A context modeler 1846 may update a probability model (e.g., probability model 1844) by increasing P_{LPS} for indication 1838 if the actual coded value of indication 1838 is not equal to V_{MPS} and by decreasing P_{LPS} for indication 1838 otherwise.

An arithmetic encoder (e.g., arithmetic encoder 1842) may determine a value in a range of a final coding interval as an arithmetic code word (e.g., arithmetic code word 1852) for binary symbols. An arithmetic encoder 1842 may determine a value in a range of a final coding interval as an arithmetic code word 1852 for binary symbols, for example, based on processing a number of binary symbols (e.g., corresponding to one or more syntax elements). The arithmetic encoder 1842 may output an arithmetic code word 1852. An arithmetic encoder 1842 may output an arithmetic code word 1852 to a bitstream that may be received and processed by a video decoder.

FIG. 18D shows an example of a decoder determining a magnitude signal of a BVD. FIG. 18D shows an example of a decoder (e.g., decoder 300 as described with respect to FIG. 3) that may receive an arithmetic code word (e.g., arithmetic code word 1852), an arithmetically decode indication (e.g., arithmetically decode indication 1838) from arithmetic code word 1852, and use indication 1838 to determine a magnitude symbol (e.g., magnitude symbol 1816) of BVD 1810.

A decoder may receive an arithmetic code word (e.g., arithmetic code word 1852) in a bitstream. The decoder may provide an arithmetic code word (e.g., arithmetic code word 1852) to an arithmetic decoder 1854. An indication 1838 may have a non-uniform probability distribution based on a method of determining indication 1838 as described herein. Therefore, arithmetic decoder 1854 may process indication 1838 in regular arithmetic decoding mode. An arithmetic decoder (e.g., arithmetic decoder 1854) may perform recursive interval subdivision as explained herein to decode symbols encoded by the arithmetic code word 1852. An arithmetic decoder (e.g., arithmetic decoder 1854) may arithmetically decode a symbol that may take a value from an m-ary source alphabet by dividing an initial coding interval into m disjoint subintervals. Each of the m disjoint subintervals may have a width proportional to the probability of the symbol having a different one of the values in the m-ary source alphabet. The value m may be equal to two and the initial coding interval may be subdivided into two disjoint intervals that each have a width proportional to the probability of a different one of the two possible values {0, 1} for binary symbols like indication 1838. The probabilities of the symbol having different values in the m-ary source alphabet may be referred to as a probability model for the symbol as described herein. The symbol may be arithmetically decoded from an arithmetic code word 1852 by determining the symbol value corresponding to the subinterval in which the arithmetic code word falls within. The decoder may sequentially decode each symbol s₁ of a sequence s={s₁, s₂, . . . , s_{N}) encoded by arithmetic code word 1852 by recursively using this interval-subdivision scheme N times and determining which subinterval arithmetic code word 1852 falls within during each iteration.

An arithmetic decoder (e.g., arithmetic decoder 1854) may receive a probability model (e.g., probability model 1844) for indication 1838 from context modeler 1846. An arithmetic decoder (e.g., arithmetic decoder 1854) may receive a probability model (e.g., probability model 1844) for indication 1838 from context modeler 1846, for example, if decoding the symbol corresponding to indication 1838. A context modeler (e.g., context modeler 1856) may determine probability model 1844 for indication 1838 by a fixed selection or by an adaptive selection from among two or more probability models as described herein with respect to context modeler 1846, as shown in FIG. 18C.

As shown in FIG. 18D, an arithmetic decoder (e.g., arithmetic decoder 1854) may provide one or more probability model update parameters 1850 to a context modeler (e.g., context modeler 1856). The arithmetic decoder 1854 may provide one or more probability model update parameters 1850 to a context modeler 1856, for example, based on (e.g., after) arithmetic decoder 1854 decoding indication 1838. The context modeler 1856 may adapt probability model 1844. The context modeler 1856 may adapt probability model 1844, for example, based on the one or more probability model update parameters 1850. The one or more probability model update parameters 1850 may comprise an actual decoded value of indication 1838. The context modeler 1856 may update probability model 1844 by increasing P_{LPS} for indication 1838 if the actual decoded value of indication 1838 is not equal to V_{MPS} and by decreasing P_{LPS} for indication 1838 otherwise.

A decoder may determine a value of magnitude symbol 1816 of BVD 1810, for example, based on the value of magnitude symbol 1816 of BVD predictor 1836 and the value of indication 1838. A decoder may determine a value of magnitude symbol 1816 of BVD 1810 based on the value of magnitude symbol 1816 of BVD predictor 1836 and the value of indication 1838, for example, after entropy decoding indication 1838. The decoder may determine the value of magnitude symbol 1816 of BVD 1810 as being equal to the magnitude symbol of BVD predictor 1836, for example, based on indication 1838 indicating that the value of magnitude symbol 1816 of BVD 1810 matches the value of magnitude symbol 1816 of BVD predictor 1836. The decoder may determine the value of magnitude symbol 1816 of BVD 1810 as being not equal to, or equal to the opposite value of, magnitude symbol 1816 of BVD predictor 1836, for example, based on indication 1838 indicating that the value of magnitude symbol 1816 of BVD 1810 does not match the value of magnitude symbol 1816 of BVD predictor 1836. Magnitude symbol 1816 of BVD predictor 1836 may have a value of “0”, that matches the value of magnitude symbol 1816 of BVD 1810. An indication 1838 may indicate that the value of magnitude symbol 1816 of BVD 1810 matches the value of magnitude symbol 1816 of BVD predictor 1836. An indication 1838 may be a single bit that may have the value “0”, for example, if the value of magnitude symbol 1816 of BVD 1810 matches the value of magnitude symbol 1816 of BVD predictor 1836. An indication 1838 may be a single bit that may have the value “1”, for example, if the value of magnitude symbol 1816 of BVD 1810 does not match the value of magnitude symbol 1816 of BVD predictor 1836. Logic 1858 may be used to determine magnitude symbol 1816 of BVD 1810. The logic 1858 may implement a logical XOR function. The indication 1838 may indicate that the first candidate among the plurality of candidates (e.g., as sorted based on their respective costs) that has a value of magnitude symbol 1816 that matches the value of magnitude symbols 1816 in BVD 1810, for example, if the magnitude symbol 1816 is non-binary.

A decoder may determine a value of magnitude symbol 1816 of BVD predictor 1836 as described herein. More specifically, the decoder may select a BVD predictor (e.g., BVD predictor 1836) from among a plurality of BVD candidates based on costs of the plurality of the BVD candidates. The BVD candidates may include a BVD candidate for each possible value of the magnitude symbol of BVD 1810. A magnitude symbol of BVD 1810 represented in binary form may only have two possible values. Therefore, the BVD candidates may include at least two BVD candidates for this representation, one for each possible value of the magnitude symbol in BVD 1810 being encoded: a first BVD candidate may be equal to BVD 1810 itself and a second BVD candidate may be equal to BVD 1810 but with the opposite, or other, value of the magnitude symbol of BVD 1810. The cost for each BVD candidate in the plurality of BVD candidates may be calculated as described herein with respect to the encoder. cost for each BVD candidate in the plurality of BVD candidates may be calculated as described herein with respect to the encoder, for example, based on a difference between a template of current block 1804 and a template of a candidate reference block. The candidate reference block may be displaced relative to the current block by a sum of the BVD candidate and BVP 1808. The decoder may select the BVD candidate with the lost cost as BVD predictor 1836.

The example approach to entropy code an indication of whether a value of a magnitude symbol of a BVD matches, or does not match, a value of the magnitude symbol of a BVD candidate used as a predictor of the BVD, as discussed herein with respect to FIGS. 18A-D, may be used with multiple magnitude symbols of the BVD. This example approach may be further used with one or more magnitude symbols of BVDₓ 1816 other than magnitude symbol 1816. For each additional magnitude symbol of BVDₓ 1816 that the example approach discussed herein with respect to FIGS. 18A-D is used, additional candidate BVPs may be determined. Using this approach, for example, to N magnitude symbols of BVDₓ 1816 (where N is an integer value), 2\hat{ }N different BVP candidates may be determined—one for each possible combination of values for the N magnitude symbols of BVDₓ 1816. Cost values may be further determined for each of the BVP candidates and sorted to determine a BVP predictor for encoding each of the N magnitude symbols of BVDₓ 1816.

The example approach to entropy code an indication of whether a value of a magnitude symbol of a BVD matches, or does not match, a value of the magnitude symbol of a BVD candidate used as a predictor of the BVD, as discussed herein with respect to FIGS. 18A-D, may be used with one or more magnitude symbols of BVD_{y} 1814 in addition or alternatively to one or more magnitude symbols of BVDₓ 1816.

The approach discussed herein with respect to FIGS. 18A-D, furthermore, may be used with respect to one or more magnitude symbols of an MVD used in inter prediction in addition to or alternatively to one or more magnitude symbols of a BVD used in IBC. For inter prediction, the terms BV, BVP, BVD, and BVD candidate used in FIGS. 18A-D may be replaced by the terms MV, MVP, MVD, and MVD based on the present disclosure.

The examples discussed herein with respect to FIGS. 18A-D may be used with IBC and inter prediction, for example, based on a translational motion model for the prediction block. The examples as described herein with respect to FIGS. 18A-D may be used with IBC and inter prediction, for example, based on an affine motion model for the prediction block.

The approach discussed herein with respect to FIGS. 18A-D to entropy code an indication of whether a value of a magnitude symbol of a BVD matches a value of the magnitude symbol of a BVD candidate used as a predictor of the BVD may be used with respect to multiple magnitude symbols of a BVD. The approach described herein, for example, may be used with respect to one or more magnitude symbols of a BVDₓ1812 other than a magnitude symbol 1816 and/or to one or more magnitude symbols of a BVD_{y} 1814. Additional candidate BVPs may be determined for each additional magnitude symbol of the BVDₓ 1812 and/or the BVD_{y} 1814 that the approach discussed herein is used. 2^{N} different BVP candidates may be determined—one for each possible combination of values for the N magnitude symbols of a BVDₓ 1812 and/or a BVD_{y}1814, for example, by using the approach described herein in concerning FIGS. 18A-D with respect to N magnitude symbols of the BVDₓ 1812 and/or the BVD_{y} 1814 (where N is an integer value). Cost values may be determined for each of the BVP candidates to determine a BVD predictor for encoding each of the N magnitude symbols of the BVDₓ 1812 and/or the BVD_{y} 1814.

Other binarizations of components BVD_{y} 1814 and BVDₓ 1816 of a BVD 1810 and components of BVD candidates may be possible other than being represented using fixed-length binary. Components BVD_{y} 1814 and BVDₓ 1816 of a BVD 1810, for example, may be represented by one of a wide range of codes that may include two parts: a prefix and a suffix. Such codes include, for example, Rice codes and Golomb codes (e.g., Golomb-Rice codes or Exponential Golomb codes). Considering FIGS. 18A-D for example, the magnitude of a horizontal component, BVDₓ 1812 of a BVD 1810, may be binarized using a Golomb-Rice code. Golomb-Rice codes have a structure as described herein, with a prefix that may indicate a range of values and a suffix that may indicate a precise value within the range of values. A Golomb-Rice code C_{gr k}(V) of order k includes a unary coded prefix and k suffix bits. The k suffix bits are a binary representation of an integer 0≤i<2^{k}. Table 1 below shows an example of a Golomb-Rice code for k=4. In the table and the following explanation, x₀, x₁, . . . , xₙ may denote bits of the code word with xₙ ∈{0, 1}.

TABLE 1

| ν | C_{gr 4}(ν) |
|---|---|
| 0, . . . , 15 | 1 x₃, x₂, x₁, x₀ |
| 16, . . . , 31 | 0 1 x₃, x₂, x₁, x₀ |
| 32, . . . , 47 | 0 0 1 x₃, x₂, x₁, x₀ |
| . | . |
| . | . |
| . | . |

The number of prefix bits may be denoted by nₚ, the number of suffix bits may be denoted by nₛ. The number of suffix bits may be nₛ=k, for the Golomb-Rice code. The number of prefix bits may be determined by:

$${n}_{p} = 1 + ⌊ \frac{v}{{2}^{k}} ⌋ . \qquad ( 19 )$$

if encoding a value v, and where └x┘ is the integer part of x. The suffix may be the nₛ-bit representation of:

vₛ=v−2^{k}(nₚ−1) (20)

The Golomb-Rice codes discussed above may use a suffix of fixed length. The length of the suffix may also be determined by the length of the prefix. Exponential Golomb codes (e.g., Exp-Golomb) may use this approach and may further be used to binarize a magnitude of a horizontal component, BVDₓ 1812, of a BVD 1810. A kth-order Exp-Golomb code C_{eg k}(v) may include a unary prefix code and/or a suffix of variable length. The number of bits in the suffix nₛ may be determined by the value nₚ as follows:

nₛ=k+nₚ−1 (21)

The number of prefix bits nₚ of C_{eg k}(v) may be determined from a value v by:

2^{k}(2ⁿ^{ₚ}⁻¹−1)≤v₂≤2^{k}(2ⁿ^{ₚ}−1) (22)

The suffix may then be the nₛ-bit representation of:

vₛ=v−2^{k}(2ⁿ^{ₚ}−1) (23)

Table 2 below shows an example of Exp-Golomb codes for k=1.

TABLE 2

| ν | C_{gr 4}(ν) |
|---|---|
| 0, 1 | 1 x₀ |
| 2, . . . , 5 | 0 1 x₁, x₀ |
| 6, . . . , 13 | 0 0 1 x₂, x₁, x₀ |
| 14, . . . , 29 | 0 0 0 1 x₃, x₂, x₁, x₀ |
| . | . |
| . | . |
| . | . |

Considering FIGS. 18A-D, a magnitude of a horizontal component, BVDₓ 1812, of a BVD 1810 may have a value of 19 in base 10, which may be represented by a Golomb-Rice code and/or an Exp-Golomb code. The magnitude of the BVDₓ 1812, for example, may be represented by the Exp-Golomb code of order k=4 with a prefix of “0001” and a suffix of “0101.” The prefix “0001” may indicate that the magnitude of the BVDₓ1812 falls within the range of values 14-29, and the suffix “0101” may indicate that the magnitude of the BVDₓ 1812 may have the precise value of 19 within the range of values of 14-29. Considering FIGS. 18A-D, a magnitude of a vertical component, BVD_{y} 1814, of a BVD 1810 may have a value of 11 in base 10, which may be represented by a Golomb-Rice code or an Exp-Golomb code. The magnitude of the BVD_{y} 1814, for example, may be represented by the Exp-Golomb code of order k=4 with a prefix of “001” and a suffix of “101.” The prefix “001” may indicate that the magnitude of the BVD_{y} 1814 falls within the range of values 6-13, and the suffix “101” may indicate that the magnitude of the BVD_{y} 1814 may have the precise value of 11 within the range of values of 6-13.

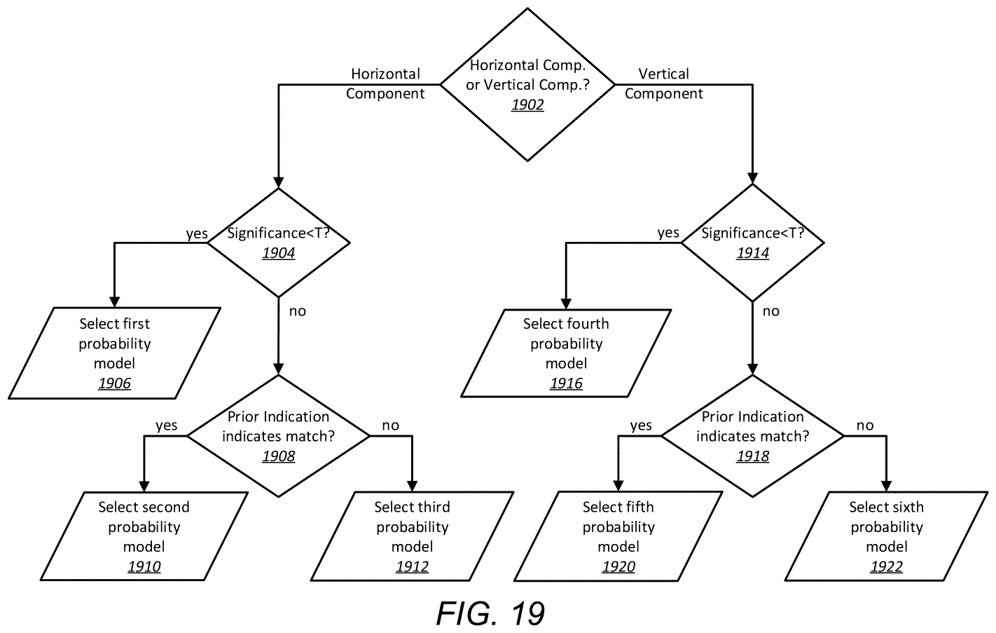

FIG. 19 shows a method for a context modeler to determine a probability model for an indication. More specifically, FIG. 19 shows a method for a context modeler 1846 to determine a probability model 1844 for an indication 1838. The steps of FIG. 19 are described herein as being performed by a context modeler 1846. One or more steps (e.g., all steps) of FIG. 19 may be performed by an encoder.

As described herein with respect to FIG. 19, at step 1902, a context modeler 1846 may determine whether a magnitude symbol 1816 of a BVD 1810 is in the horizontal component of BVD 1810 (i.e., in BVDₓ 1812) or is in the vertical component of BVD 1810 (i.e., BVD_{y} 1814).

The context modeler 1846 would proceed to step 1904, for example, if a magnitude symbol 1816 of a BVD 1810 is the horizontal component of the BVD 1810 (i.e., in BVDₓ 1812). At step 1904, the context modeler 1846 may determine whether the significance of magnitude symbol 1816 of BVD 1810 is less than a threshold value T. A significance of magnitude symbol 1816, for example, may refer to the position (and/or index of the position) of magnitude symbol 1816 and/or the change in value of the BVD 1810 (and/or the BVDₓ 1812 of the BVD 1810) for an incremental change in a value of magnitude symbol 1816 of BVD 1810. A change in value of the BVD 1810 and/or the BVDₓ 1812 of the BVD 1810 for an incremental change in value of magnitude symbol 1816 of BVD 1810 may be determined as 2⁽ⁿ⁻¹⁾, where n is the bit position of a magnitude symbol 1816 in BVDₓ 1812 of BVD 1810. The change in a value of a BVD 1810 and/or a BVDₓ 1812 of the BVD 1810 for an incremental change in value of a magnitude symbol 1816 of BVD 1810 may be determined as 2⁽⁴⁻¹⁾ or 8, for example, if n=4. A change in a value of a BVD 1810 and/or a BVDₓ 1812 of the BVD 1810 for an incremental change in value of a magnitude symbol 1816 of BVD 1810 may be multiplied by a scaling factor, for example, before being compared to a threshold value T. The significance of a magnitude symbol 1816 may be determined as S=F*2⁽ⁿ⁻¹⁾, for example, for a scaling factor F. The value of the scaling factor F may be defined using an integer motion vector (IMV) flag, for example, if a magnitude symbol 1816 is part of a suffix of a Golomb-Rice code. The scaling factor F may be set equal to 4, for example, if the IMV flag is equal to 1, or the scaling factor F may be set equal to 0 otherwise. The threshold value T may be set equal to a value of 4.

A context modeler 1846 may proceed to step 1906, for example, if the context modeler 1846 determined, at step 1904, that the significance of magnitude symbol 1816 is less than a threshold value T. At step 1906, the context modeler 1846 may select, among a plurality of probability models, a first probability model as probability model 1844.

Alternatively, a context modeler 1846 may proceed to step 1908, for example, if the context modeler 1846 determined, at step 1904, that the significance of magnitude symbol 1816 is greater than or equal to a threshold value T. As described herein, the approach discussed above with respect to FIGS. 18A-D to entropy code an indication of whether a value of a magnitude symbol of a BVD matches a value of the magnitude symbol of a BVD candidate used as a predictor of the BVD may be used with respect to multiple magnitude symbols of the BVD. Entropy coding, for example, may be used with respect to one or more magnitude symbols of BVDₓ 1812 other than a magnitude symbol 1816 and/or to one or more magnitude symbols of BVD_{y} 1814. The context modeler 1846 may use an indication of whether a value of another magnitude symbol (e.g., a magnitude symbol that may be different from the magnitude symbol 1816) of a BVD 1810 matches a value of the same magnitude symbol of a BVD candidate used as a predictor of the BVD to select probability model 1844 from among a plurality of probability models. The indication may correspond to an indication that was entropy coded prior to the indication determined for magnitude symbol 1816. The context modeler 1846 may select a second probability model, from among a plurality of probability models, at step 1910, as the probability model 1844. The context modeler 1846 may select the second probability model as the probability model 1844, for example, based on the prior indication indicating the magnitude symbol (e.g., a magnitude symbol that may be different from the magnitude symbol 1816) of a BVD 1810 matches the value of the same magnitude symbol of the BVD candidate used as a predictor of the BVD. The context modeler 1846 may select a third probability model, from among a plurality of probability models, at step 1912, as the probability model 1844. The context modeler 1846 may select the third probability model as the probability model 1844, for example, based on the prior indication indicating the magnitude symbol (e.g., a magnitude symbol may be different from the magnitude symbol 1816) of the BVD 1810 does not match the value of the same magnitude symbol of the BVD candidate used as a predictor of the BVD. Indications that may be determined for a BVD 1810 based on the approach discussed herein in with respect to FIGS. 18A-D may be entropy coded in order from most significant to least significant bit position. Indications determined for a BVD 1810 based on the approach discussed herein in with respect to FIGS. 18A-D may be entropy coded in order from least significant to most significant bit position.

A context modeler 1846 may proceed to step 1914, for example, if the magnitude symbol 1816 of a BVD 1810 is determined to be in a vertical component of the BVD 1810 (i.e., in BVD_{y} 1814) at step 1902. At step 1914, the context modeler 1846 may determine whether the significance of magnitude symbol 1816 of BVD 1810 is less than a threshold value T. A significance of magnitude symbol 1816 may refer to, for example, the position and/or index of the position of magnitude symbol 1816 or a change in value of a BVD 1810 for an incremental change in value of a magnitude symbol 1816 of the BVD 1810. A change in value of a BVD 1810 and/or a BVDₓ 1812 of the BVD 1810 for an incremental change in value of the magnitude symbol 1816 of the BVD 1810 may be multiplied by a scaling factor, for example, before being compared to the threshold value T. The significance of magnitude symbol 1816 may be determined as S=F*2⁽ⁿ⁻¹⁾, for example, for a scaling factor F. The value of the scaling factor F may be defined using an integer motion vector (“IMV”) flag, for example, if the magnitude symbol 1816 is part of a suffix of a Golomb-Rice code. The scaling factor F may be set equal to 4, if the flag is equal to 1 and set to 0 otherwise. The threshold value T may be set equal to a value of 4.

A context modeler 1846 may proceed to step 1916, for example, if the context modeler 1846 determined, at step 1914, that a significance of magnitude symbol 1816 is less than a threshold value T. At step 1916, the context modeler 1846 may select a fourth probability model, among a plurality of probability models, as the probability model 1844.

Alternatively, a context modeler 1846 may proceed to step 1918, for example, if the context modeler 1846 determined, at step 1914, that a significance of a magnitude symbol 1816 is greater than or equal to a threshold value T. As mentioned herein, the approach discussed above with respect to FIGS. 18A-D to entropy code an indication of whether a value of a magnitude symbol of a BVD matches a value of the magnitude symbol of a BVD candidate used as a predictor of the BVD may be used with respect to multiple magnitude symbols of the BVD. Entropy coding, for example, may be further used with respect to one or more magnitude symbols of BVDₓ 1812 other than the magnitude symbol 1816 and/or to one or more magnitude symbols of BVD_{y} 1814. The context modeler 1846 may use an indication of whether a value of another magnitude symbol (e.g., a magnitude symbol that may be different from the magnitude symbol 1816) of the BVD 1810 matches a value of the same magnitude symbol of a BVD candidate used as a predictor of the BVD to select probability model 1844 from among a plurality of probability models. The indication may correspond to an indication that was entropy coded prior to the indication determined for magnitude symbol 1816. The context modeler 1846 may select a fifth probability model, from among a plurality of probability models, at step 1920, as a probability model 1844. The context modeler 1846 may select the fifth probability model as a probability model 1844, for example, based on a prior indication indicating the magnitude symbol (e.g., a magnitude symbol that may be different from the magnitude symbol 1816) of the BVD 1810 matches the value of the same magnitude symbol of the BVD candidate used as a predictor of the BVD. The context modeler 1846 may select a sixth probability model, from among a plurality of probability models, in step 1922, as a probability model 1844. The context modeler 1846 may select the sixth probability model as a probability model 1844, for example, based on a prior indication indicating the magnitude symbol (e.g., a magnitude symbol that may be different from the magnitude symbol 1816) of the BVD 1810 does not match the value of the same magnitude symbol of the BVD candidate used as a predictor of the BVD. Indications determined for a BVD 1810 based on the approach discussed herein with respect to FIGS. 18A-D may be entropy coded in order from most significant to least significant bit position. Indications determined for a BVD 1810 based on the approach discussed herein in with respect to FIGS. 18A-D may be entropy coded in order from least significant to most significant bit position.

A context modeler 1846 may select a probability model 1844 as described herein in with respect to FIG. 19 without regard to whether magnitude symbol 1816 is in the horizontal or vertical component of BVD 1810 (e.g., by omitting step 1902). A context modeler 1846 may further or alternatively select a probability model 1844 as described herein in with respect to FIG. 19 without regard to the significance of magnitude symbol 1816 being less than a threshold value T (e.g., by omitting steps 1904, 1906, 1914, and/or 1916).

A context modeler 1856, and/or a decoder, may determine a probability model 1844 for an indication 1838 by a fixed selection and/or by an adaptive selection from among two or more probability models in the same manner as described herein in with respect to FIG. 19 for a context modeler 1846.

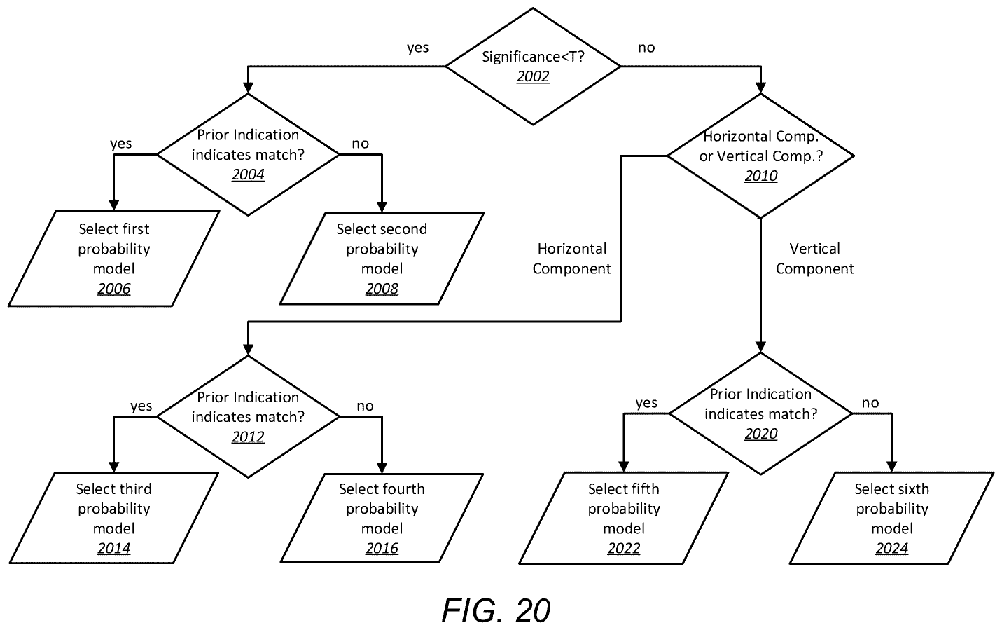

FIG. 20 shows an example method for a context modeler to determine a probability model for an indication 1838. More specifically, FIG. 20 shows an example method for a context modeler 1846 to determine a probability model 1844 for an indication 1838. One or more steps of FIG. 20 are described herein as being performed by a context modeler (e.g., context modeler 1846). One or more steps (e.g. all steps) of FIG. 20, however, may be performed by an encoder.

As discussed herein with respect to FIG. 20, a context modeler 1846 may determine, at step 2002, whether a significance of a magnitude symbol 1816 of a BVD 1810 is less than a threshold value T. The significance of the magnitude symbol 1816 may refer to, for example, the position and/or index of the position of the magnitude symbol 1816 or the change in a value of the BVD 1810 and/or a BVDₓ 1812 of the BVD 1810 for an incremental change in a value of the magnitude symbol 1816 of the BVD 1810. The change in the value of the BVD 1810 and/or the BVDₓ 1812 of the BVD 1810 for an incremental change in value of magnitude symbol 1816 of BVD 1810 may be determined as 2⁽ⁿ⁻¹⁾, where n is the bit position of magnitude symbol 1816 in BVDₓ1812 of BVD 1810. The change in the value of the BVD 1810 and/or the BVDₓ 1812 of the BVD 1810 for an incremental change in a value of a magnitude symbol 1816 of the BVD 1810 may be determined as 2⁽⁴⁻¹⁾ or 8, for example, if n=4. A change in a value of a BVD 1810 and/or a BVDₓ 1812 of a BVD 1810 for an incremental change in a value of a magnitude symbol 1816 of the BVD 1810 may be multiplied by a scaling factor, for example, before being compared to the threshold value T. The significance of a magnitude symbol 1816 may be determined as S=F*2⁽ⁿ⁻¹⁾, for example, for a scaling factor F. The value of a scaling factor F may be defined using an IMV flag, for example, if a magnitude symbol 1816 is part of a suffix of a Golomb-Rice code. The scaling factor F may be set equal to 4, for example, if the IMV flag is equal to 1 and set to 0 otherwise. The threshold value T may be set equal to a value of 4.

The context modeler 1846 may proceed to step 2004, for example, if the context modeler 1846 determined, at step 2002, that the significance of magnitude symbol 1816 is less than the threshold value T. As described herein with respect to FIGS. 18A-D, entropy coding may be used with respect to multiple magnitude symbols of a BVD as an indication of whether a value of a magnitude symbol of a BVD matches a value of the magnitude symbol of a BVD candidate used as a predictor of the BVD. Entropy coding, for example, may be used with respect to one or more magnitude symbols of a BVDₓ 1812 other than magnitude symbol 1816 and/or to one or more magnitude symbols of a BVD_{y} 1814. A context modeler (e.g., context modeler 1846) may use an indication of whether a value of another magnitude symbol (e.g., a magnitude symbol that may be different from magnitude symbol 1816) of a BVD 1810 matches a value of the same magnitude symbol of a BVD candidate used as a predictor of the BVD to select probability model 1844 from among a plurality of probability models. The indication may correspond to an indication that was entropy coded prior to the indication determined for magnitude symbol 1816. The context modeler 1846 may select a first probability model, from among a plurality of probability models, at step 2006 as a probability model 1844, for example, based on a prior indication indicating a magnitude symbol (e.g., a magnitude symbol that may be different from a magnitude symbol 1816) of the BVD 1810 matches the value of the same magnitude symbol of the BVD candidate used as a predictor of the BVD. The context modeler 1846 may select a second probability model, from among a plurality of probability models, at step 2008, as a probability model 1844, for example, based on the prior indication indicating the magnitude symbol (e.g., a magnitude symbol different from the magnitude symbol 1816) of the BVD 1810 does not match the value of the same magnitude symbol of the BVD candidate used as a predictor of the BVD. Indications determined for the BVD 1810 based on the approach discussed herein with respect to FIGS. 18A-D may be entropy coded in order from most significant to least significant bit position. Indications determined for BVD 1810 based on the approach discussed herein with respect to FIGS. 18A-D may be entropy coded in order from least significant to most significant bit position.

Alternatively, the context modeler (e.g., context modeler 1846) may proceed to step 2010, for example, if the context modeler determined, at step 2002, that the significance of a magnitude symbol 1816 is greater than or equal to a threshold value T. At step 2010, a context modeler 1846 (e.g., context modeler 1846) may determine whether a magnitude symbol 1816 of a BVD 1810 is in the horizontal component of the BVD 1810 (e.g., in BVDₓ 1812) or is in the vertical component of the BVD 1810 (e.g., BVD_{y} 1814).

The context modeler 1846 may proceed to step 2012, for example, if a magnitude symbol 1816 of a BVD 1810 is a horizontal component of the BVD 1810 (e.g., in BVDₓ1812). The disclosure discussed herein with respect to FIGS. 18A-D to entropy code an indication of whether a value of a magnitude symbol of a BVD matches a value of the magnitude symbol of a BVD candidate used as a predictor of the BVD may be used with respect to multiple magnitude symbols of the BVD. The disclosure discussed herein with respect to FIGS. 18A-D to entropy code an indication of whether a value of a magnitude symbol of a BVD matches a value of the magnitude symbol of a BVD candidate used as a predictor of the BVD may be used, for example, with respect to one or more magnitude symbols of a BVDₓ 1812 other than a magnitude symbol 1816. Additionally or alternatively, the disclosure discussed herein with respect to FIGS. 18A-D to entropy code an indication of whether a value of a magnitude symbol of a BVD matches a value of the magnitude symbol of a BVD candidate used as a predictor of the BVD may be used, for example, with respect to one or more magnitude symbols of a BVD_{y} 1814. A context modeler 1846, for example, may use an indication of whether a value of another magnitude symbol (e.g., a magnitude symbol that may be different from a magnitude symbol 1816) of the BVD 1810 matches a value of the same magnitude symbol of a BVD candidate used as a predictor of the BVD to select probability model 1844 from among a plurality of probability models. The indication may correspond to an indication that was entropy coded prior to the indication determined for a magnitude symbol 1816. The context modeler 1846 may select a third probability model, from among a plurality of probability models, at step 2014, as probability model 1844, for example, based on the prior indication indicating the magnitude symbol (e.g., a magnitude symbol that may be different from a magnitude symbol 1816) of the BVD 1810 matches the value of the same magnitude symbol of the BVD candidate used as a predictor of the BVD. The context modeler 1846 may select a fourth probability model, from among a plurality of probability models, in step 2016, as probability model 1844, for example, based on the prior indication indicating a magnitude symbol (e.g., a magnitude symbol may be different from a magnitude symbol 1816) of the BVD 1810 does not match the value of the same magnitude symbol of the BVD candidate used as a predictor of the BVD. Indications determined for the BVD 1810 based on the disclosure and approach discussed herein with respect to FIGS. 18A-D may be entropy coded in order from most significant to least significant bit position. Indications determined for a BVD 1810 based on the disclosure and approach discussed herein with respect to FIGS. 18A-D may be entropy coded in order from least significant to most significant bit position.

The context modeler 1846 may proceed to step 2020, for example, if it is determined at step 2010 that a magnitude symbol 1816 of the BVD 1810 is in a vertical component of the BVD 1810 (e.g., in BVD_{y} 1814). Entropy coding an indication of whether a value of a magnitude symbol of a BVD matches a value of the magnitude symbol of a BVD candidate used as a predictor of the BVD may be used with respect to multiple magnitude symbols of the BVD. Entropy coding may be used with respect to one or more magnitude symbols of a BVDₓ 1812 other than a magnitude symbol 1816 and/or to one or more magnitude symbols of a BVD_{y} 1814. The context modeler 1846 may use an indication of whether a value of another magnitude symbol (e.g., a magnitude symbol that may be different from the magnitude symbol 1816) of the BVD 1810 matches a value of the same magnitude symbol of a BVD candidate used as a predictor of the BVD to select a probability model 1844 from among a plurality of probability models. The indication may correspond to an indication that may have been entropy coded prior to the indication determined for magnitude symbol 1816. The context modeler 1846 may select a fifth probability model, from among a plurality of probability models, at step 2022, as a probability model 1844, for example, based on the prior indication indicating the magnitude symbol (e.g., a magnitude symbol that may be different from a magnitude symbol 1816) of the BVD 1810 matches the value of the same magnitude symbol of the BVD candidate used as a predictor of the BVD. The context modeler 1846 may select a sixth probability model, from among a plurality of probability models, at step 2024 as a probability model 1844, for example, based on the prior indication indicating the magnitude symbol (e.g., a magnitude symbol may be different from a magnitude symbol 1816) of the BVD 1810 does not match the value of the same magnitude symbol of the BVD candidate used as a predictor of the BVD. Indications determined for BVD 1810 based on the disclosure and approach discussed herein with respect to FIGS. 18A-D may be entropy coded in order from most significant to least significant bit position. Indications determined for BVD 1810 based on the disclosure and approach discussed herein with respect to FIGS. 18A-D may be entropy coded in order from least significant to most significant bit position.

The context modeler 1846 may select a probability model 1844 as described herein with respect to FIG. 20 without regard to whether the magnitude symbol 1816 is the horizontal or vertical component of the BVD 1810 (e.g., by omitting step 2010 and step 2012 or by omitting step 2010 and step 2020). The context modeler 1846 may further, or alternatively, select a probability model 1844 as described herein with respect to FIG. 20 without regard to a significance of a magnitude symbol 1816 being less than a threshold value T (e.g., by omitting step 2002 and step 2004 or by omitting step 2002 and step 2010).

The context modeler (e.g., context modeler 1856), or a decoder, may determine a probability model 1844 for an indication 1838 by a fixed selection and/or by an adaptive selection from among two or more probability models, in the same manner as described herein with for the context modeler 1846 discussed herein with respect to FIG. 20.

More than one previously coded bin of a suffix may be used to determine a context of a coded suffix bin. One or more coded bins of a suffix may indicate a correctness of a prediction of real bins (e.g., bins of a suffix that was selected by an encoder for this syntax element). It may be more probable that a current bin may be predicted correctly, for example, if a previous bin is also predicted correctly. A set of predicted bins coded in a coding order and having a probabilistic dependency between them may be modelled using a Markov chain. Markov chains, also referred to as discrete-time Markov chains, may be explained as follows. This sequence is said to follow a kth-order Markov model if

P(xₙ|xₙ₋₁, . . . ,xₙ₋ₖ)=P(xₙ|xₙ₋₁, . . . ,xₙ₋ₖ, . . . ) (24)

Knowledge of past k symbols may be equivalent to knowledge of an entire past history of a process. Thus, given a probability of some previously coded bins, a Markov chain model may be used to predict a probability for the next coding bins.

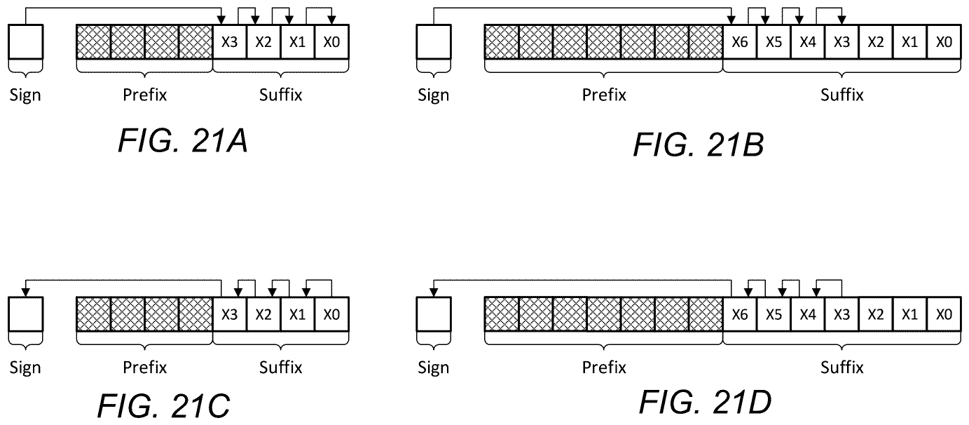

FIGS. 21A-21D show examples of deriving a context model using 1^{st}-order Markov models. With respect to FIG. 21A, a context model for a less significant suffix bin may be derived according to a value of a previous more significant bin including a sign. As shown in FIG. 21B, some least significant suffix bins may be bypass-coded; that is, context models may not be selected for the least significant bins. FIG. 21C shows a different approach where a context model for a more significant suffix bin, including a sign, may be derived by using a value of one previous more significant bin. Similar to FIG. 21B, FIG. 21D shows that some bins may be bypass-coded so that such bins may not be taken into consideration, for example, if selecting a context model for other bins.

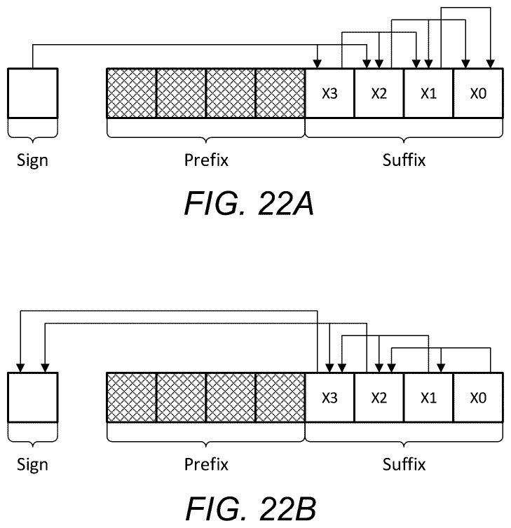

FIGS. 22A and 22B show examples of deriving a context model using 2^{nd}-order Markov chains. Two (2) previous sign or suffix bins may be used to derive a context model for a given bin, for example if selecting context models for suffix bins by using a 2^{nd}-order Markov chain. As shown in FIG. 22A, a context model for a less significant bin may be selected based on values of up to two (2) more significant bin. FIG. 22B shows a different case for deriving a context model for a more significant bin based on up to two (2) less significant bins.

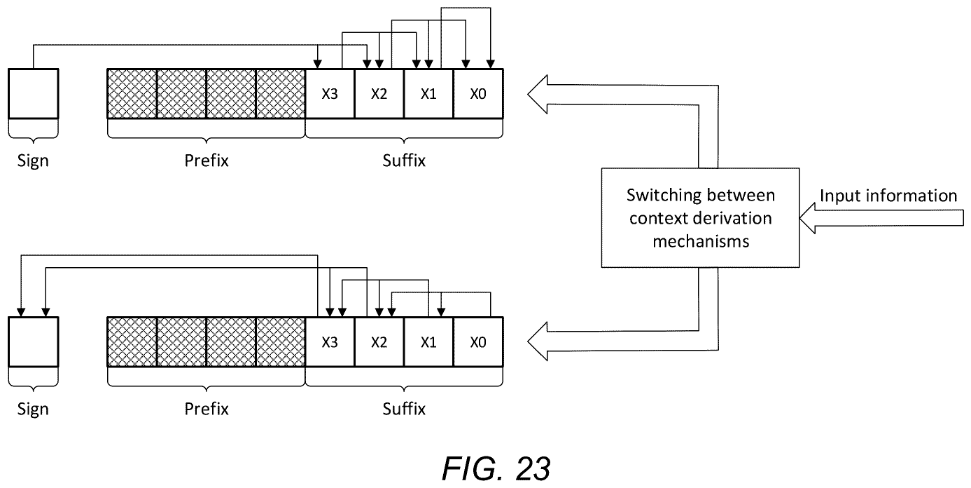

FIG. 23 shows an example of switching between context derivation techniques. More specifically, FIG. 23 shows an example of a mechanism to switch between the two (2) context derivation techniques discussed herein. The two (2) context derivation techniques may be as described herein with respect to FIGS. 21A-21D for 1^{st}-order Markov chains (first context derivation technique), and in FIGS. 22A and 22B for 2^{nd}-order Markov chains (second context derivation technique). Data from neighboring CUs may be used as input information for determining the switching. The context derivation technique shown in FIGS. 21C and 21D or FIG. 22B may be used, for example, if the number of correctly guessed hypotheses in a BVD suffix of a neighboring CU is large for less significant bins. Otherwise, the order of the context derivation may be defined as FIGS. 21A and 21B and FIG. 22A illustrate for 1^{st}—and 2^{nd}-order Markov chains, respectively.

The coding order of sign and/or suffix bins may be different than the order of prediction of bins if performing hypothesis checking. Prediction of bins may be performed in an order of highest significance to lowest significance, wherein a sign bin may be considered to have higher significance than the most significant predicted bin of suffix. At an encoder, a binary string of predicted bins may be signaled in a different order (e.g., from lower significant bins to higher significant bins). Correspondingly, at a decoder, the binary string may be restored during a parsing process in the same order as it is coded at the encoder. Context selection for encoding and/or decoding of a bin may utilize previously coded bins. Thus, the coding order for predicted bin signaling determines whether context are derived from bins of lower significance or bins of higher significance.

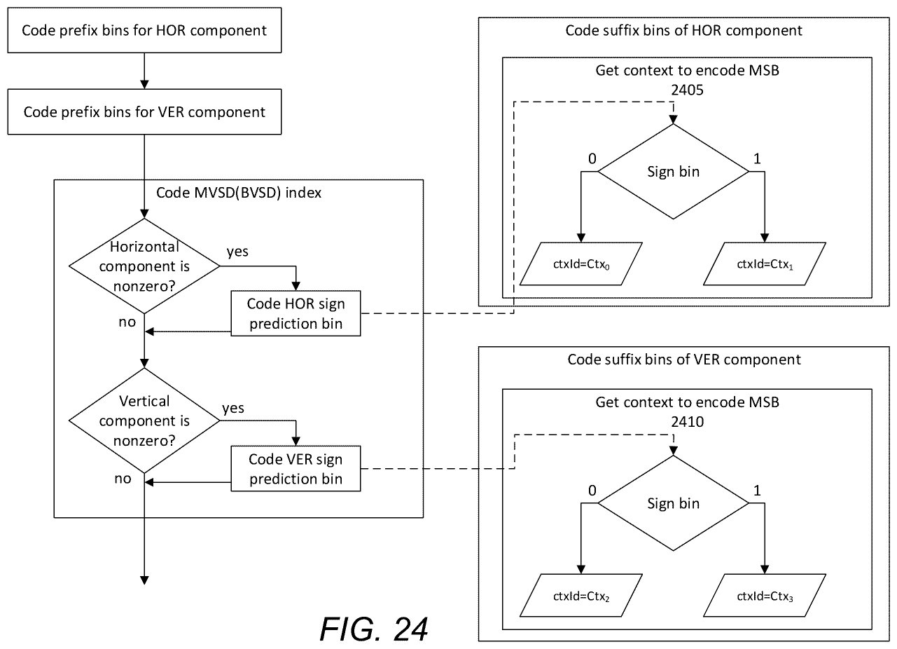

A value of a previously coded bin of a suffix of a vector difference component may be set equal to a bin that may encode correctness of a prediction of a sign for this component, for example, if the most significant bin of a suffix is coded. FIG. 24 shows an example method for selecting the most significant bins (MSB) of horizontal and vertical components of a vector difference. A BVSD (Block Vector Sign Derivation) index may be a binary string that comprises a set of bins. The number of bins in a BVSD binary string may depend on a number of non-zero component in the indicated BVD. These bins may be utilized as a part of previously coded bins sequence. FIG. 24 shows an example of a most significant bin (MSB) of a suffix that may be context coded and the context of the MSB that may be determined using a previously indicated sign prediction bin, which may be a part of a BVSD index. Context derivation for the MSB of suffixes of horizontal and vertical components may be performed at “Get context to encode MSB” stage 2405 and 2410. Here, contexts may be selected on the basis of the corresponding BVSD bin value and/or depending on a component that may be indicated (e.g., a horizontal component or a vertical component). The dashed line in FIG. 20 shows a relationships between values that may be signaled in a BVSD index coding with conditions checked for BVD suffix bin. Context derivation for the MSB of suffixes of horizontal components may be performed at the “Get context to encode MSB” 2405, for example, if a horizontal component is nonzero. Context derivation for the MSB of suffixes of horizontal components may be performed at the “Get context to encode MSB” 2410, for example, if a vertical component is nonzero. In case of MV coding, the same approach may be used to select context for MVD suffix bins based on MVSD index.

HOR and VER sign prediction values may be encoded, for example, as a part of an index. The prediction value may be a BVSD (Block Vector Sign Derivation) index for a block vector difference. Whereas, the prediction value may be a MVSD (Motion Vector Sign Derivation) index for a motion vector difference.

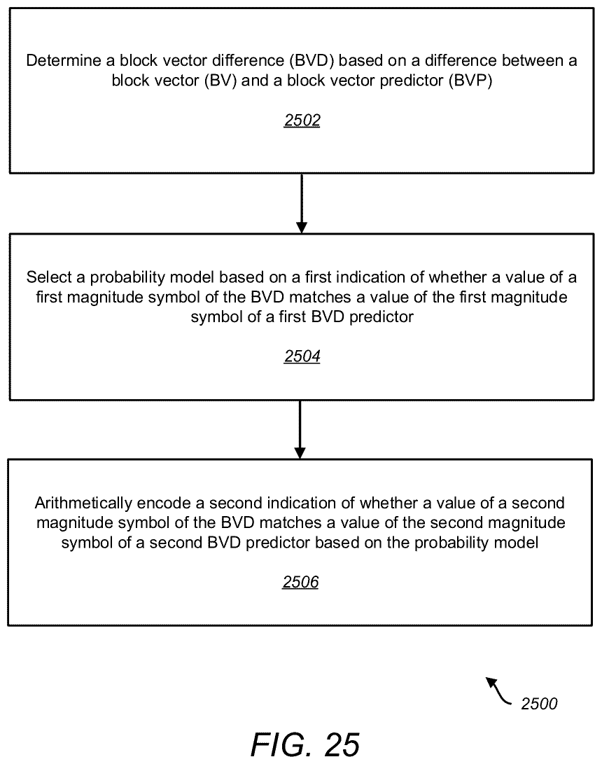

FIG. 25 shows an example method of encoding an indication of whether a value of a magnitude symbol matches a value of a prediction of that magnitude symbol. More specifically, FIG. 25 shows a flowchart 2500 of an example method of encoding (e.g., arithmetically encoding) an indication of whether a value of a magnitude symbol matches a value of a prediction of that magnitude symbol based on a probability model. One or more steps of the example method shown in the flowchart 2500 may be implemented by an encoder (e.g., an encoder as described herein with respect to FIG. 2). At step 2502, the encoder may determine a block vector difference (BVD), for example, based on a difference between a block vector (BV) and a block vector predictor (BVP). At step 2504, the encoder may select a probability model. The encoder may select a probability model, for example, based on a first indication of whether a value of a first magnitude symbol of the BVD matches a value of a first magnitude symbol of a first BVD predictor.

The encoder may select a probability model, for example, based on a significance of a second magnitude symbol. A significance of the second magnitude symbol may be determined, for example, based on a position of the second magnitude symbol in a BVD. A significance of a second magnitude symbol may be determined, for example, based on a change in a value of the BVD for an incremental change in value of the second magnitude symbol of the BVD. The encoder may select a probability model, for example, based on a size of a block that may be predicted based on a BVD. The encoder may further select a probability model based on a directional component of a BVD comprising a first magnitude symbol and/or a second magnitude symbol. A directional component of a BVD may be one of a horizontal component and/or a vertical component. The encoder may select a probability model based on a third indication of whether a value of a third magnitude symbol of a BVD matches a value of the third magnitude symbol of a third BVD predictor.

At step 2506, the encoder may encode (e.g., arithmetically encode) a second indication of whether a value of a second magnitude symbol of a BVD matches a value of the second magnitude symbol of a second BVD predictor based on the probability model. A first indication may be encoded (e.g., arithmetically encoded), for example, before the second indication.

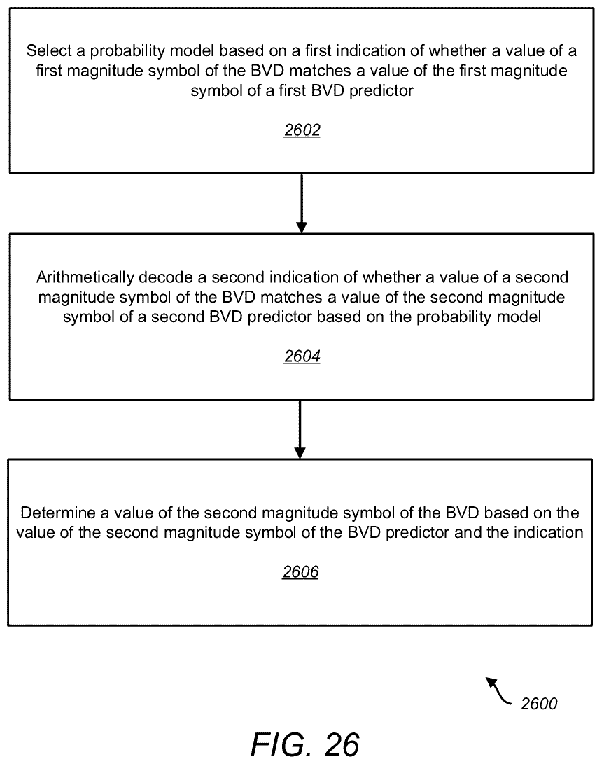

FIG. 26 shows an example method of determining a value of a magnitude symbol. More specifically, FIG. 26 shows a flowchart 2600 of an example method of determining a value of a magnitude symbol based on a value of a magnitude predictor and an arithmetically decoded indication. One or more steps of the method shown in the flowchart 2600 may be implemented by a decoder (e.g., a decoder as described herein with respect to FIG. 3). At step 2602, a decoder may select a probability model. The decoder may select a probability model, for example, based on a first indication of whether a value of a first magnitude symbol of a block vector difference (BVD) matches a value of the first magnitude symbol of a first BVD predictor.

The decoder may select a probability model based on a significance of a second magnitude symbol. A significance of the second magnitude symbol may be determined, for example, based on a position of the second magnitude symbol in a BVD. A significance of a second magnitude symbol may be determined, for example, based on a change in value of a BVD for an incremental change in value of the second magnitude symbol of the BVD.

The decoder may select a probability model, for example, based on a size of a block that may be predicted based on a BVD. The decoder may select a probability model, for example, based on a directional component of the BVD comprising a first magnitude symbol and a second magnitude symbol. A directional component of the BVD may be one of a horizontal component and/or a vertical component. The decoder may select a probability model, for example, based on a third indication of whether a value of a third magnitude symbol of a BVD matches a value of the third magnitude symbol of a third BVD predictor.

At step 2604, the decoder may decode (e.g., arithmetically decode) a second indication of whether a value of a second magnitude symbol of a BVD matches a value of the second magnitude symbol of a second BVD predictor based on the probability model. At step 2606, the decoder may determine a value of a second magnitude symbol of a BVD, for example, based on the value of the second magnitude symbol of the BVD predictor and the indication. A first indication may be decoded (e.g., arithmetically decoded), for example, before a second indication.

The disclosure and methods discussed herein with respect to FIGS. 25-26 may be used with respect to one or more magnitude symbols of a MVD used in inter prediction in addition to. or alternatively to. one or more magnitude symbols of a BVD used in IBC. The terms BV, BVP, BVD, and BVD candidate may be replaced by the terms MV, MVP, MVD, and MVD for inter prediction.

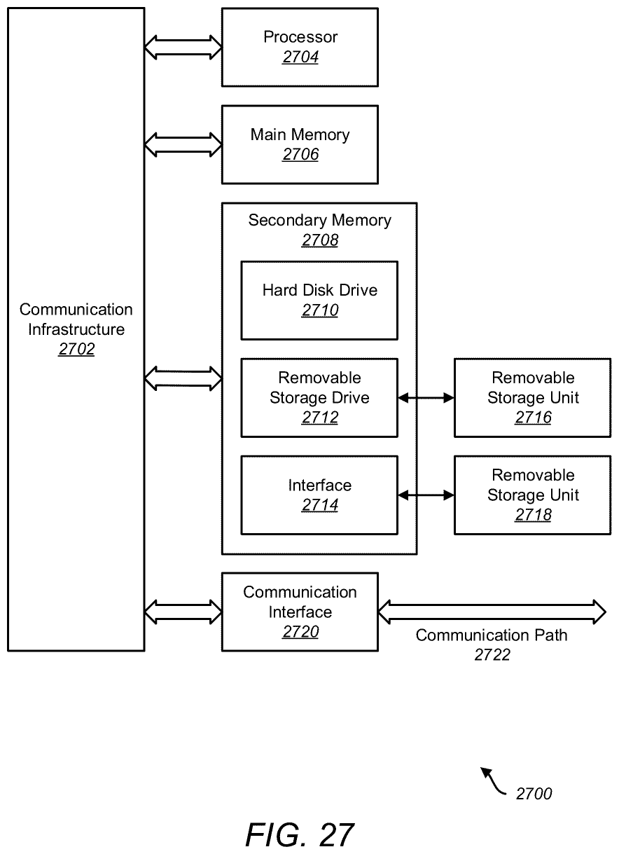

FIG. 27 shows an example computer system in which examples of the present disclosure may be implemented. For example, the example computer system 2700 shown in FIG. 27 may implement one or more of the methods described herein. For example, various devices and/or systems described herein (e.g., in FIGS. 1, 2, and 3) may be implemented in the form of one or more computer systems 2700. Furthermore, each of the steps of the flowcharts depicted in this disclosure may be implemented on one or more computer systems 2700.

The computer system 2700 may comprise one or more processors, such as a processor 2704. The processor 2704 may be a special purpose processor, a general purpose processor, a microprocessor, and/or a digital signal processor. The processor 2704 may be connected to a communication infrastructure 2702 (for example, a bus or network). The computer system 2700 may also comprise a main memory 2706 (e.g., a random access memory (RAM)), and/or a secondary memory 2708.

The secondary memory 2708 may comprise a hard disk drive 2710 and/or a removable storage drive 2712 (e.g., a magnetic tape drive, an optical disk drive, and/or the like). The removable storage drive 2712 may read from and/or write to a removable storage unit 2716. The removable storage unit 2716 may comprise a magnetic tape, optical disk, and/or the like. The removable storage unit 2716 may be read by and/or may be written to the removable storage drive 2712. The removable storage unit 2716 may comprise a computer usable storage medium having stored therein computer software and/or data.

The secondary memory 2708 may comprise other similar means for allowing computer programs or other instructions to be loaded into the computer system 2700. Such means may include a removable storage unit 2718 and/or an interface 2714. Examples of such means may comprise a program cartridge and/or cartridge interface (such as in video game devices), a removable memory chip (such as an erasable programmable read-only memory (EPROM) or a programmable read-only memory (PROM)) and associated socket, a thumb drive and USB port, and/or other removable storage units 2718 and interfaces 2714 which may allow software and/or data to be transferred from the removable storage unit 2718 to the computer system 2700.

The computer system 2700 may also comprise a communications interface 2720. The communications interface 2720 may allow software and data to be transferred between the computer system 2700 and external devices. Examples of the communications interface 2720 may include a modem, a network interface (e.g., an Ethernet card), a communications port, etc. Software and/or data transferred via the communications interface 2720 may be in the form of signals which may be electronic, electromagnetic, optical, and/or other signals capable of being received by the communications interface 2720. The signals may be provided to the communications interface 2720 via a communications path 2722. The communications path 2722 may carry signals and may be implemented using wire or cable, fiber optics, a phone line, a cellular phone link, an RF link, and/or any other communications channel(s).

A computer program medium and/or a computer readable medium may be used to refer to tangible storage media, such as removable storage units 2716 and 2718 or a hard disk installed in the hard disk drive 2710. The computer program products may be means for providing software to the computer system 2700. The computer programs (which may also be called computer control logic) may be stored in the main memory 2706 and/or the secondary memory 2708. The computer programs may be received via the communications interface 2720. Such computer programs, when executed, may enable the computer system 2700 to implement the present disclosure as discussed herein. In particular, the computer programs, when executed, may enable the processor 2704 to implement the processes of the present disclosure, such as any of the methods described herein. Accordingly, such computer programs may represent controllers of the computer system 2700.

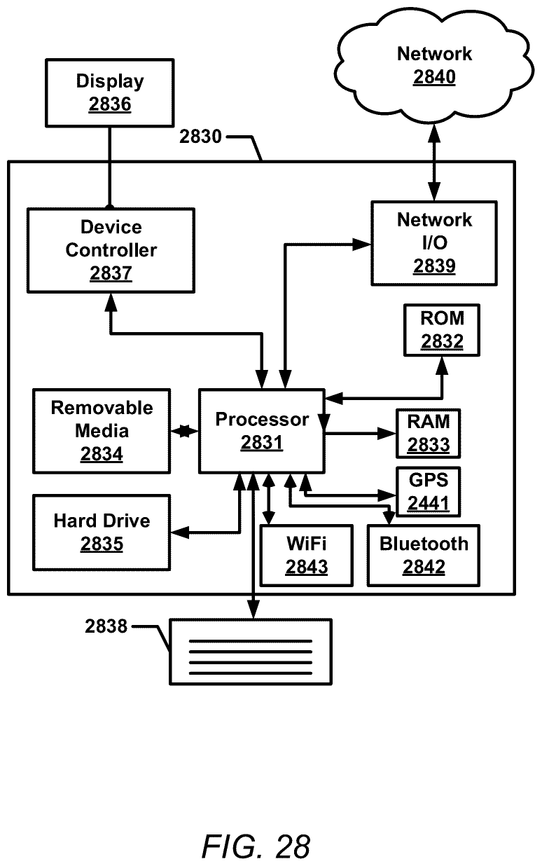

FIG. 28 shows example elements of a computing device that may be used to implement any of the various devices described herein, including, for example, a source device (e.g., 102), an encoder (e.g., 200), a destination device (e.g., 106), a decoder (e.g., 300), and/or any computing device described herein. The computing device 2830 may include one or more processors 2831, which may execute instructions stored in the random-access memory (RAM) 2833, the removable media 2834 (such as a Universal Serial Bus (USB) drive, compact disk (CD) or digital versatile disk (DVD), or floppy disk drive), or any other desired storage medium. Instructions may also be stored in an attached (or internal) hard drive 2835. The computing device 2830 may also include a security processor (not shown), which may execute instructions of one or more computer programs to monitor the processes executing on the processor 2831 and any process that requests access to any hardware and/or software components of the computing device 2830 (e.g., ROM 2832, RAM 2833, the removable media 2834, the hard drive 2835, the device controller 2837, a network interface 2839, a GPS 2841, a Bluetooth interface 2842, a WiFi interface 2843, etc.). The computing device 2830 may include one or more output devices, such as the display 2836 (e.g., a screen, a display device, a monitor, a television, etc.), and may include one or more output device controllers 2837, such as a video processor. There may also be one or more user input devices 2838, such as a remote control, keyboard, mouse, touch screen, microphone, etc. The computing device 2830 may also include one or more network interfaces, such as a network interface 2839, which may be a wired interface, a wireless interface, or a combination of the two. The network interface 2839 may provide an interface for the computing device 2830 to communicate with a network 2840 (e.g., a RAN, or any other network). The network interface 2839 may include a modem (e.g., a cable modem), and the external network 2840 may include communication links, an external network, an in-home network, a provider's wireless, coaxial, fiber, or hybrid fiber/coaxial distribution system (e.g., a DOCSIS network), or any other desired network. Additionally, the computing device 2830 may include a location-detecting device, such as a global positioning system (GPS) microprocessor 2841, which may be configured to receive and process global positioning signals and determine, with possible assistance from an external server and antenna, a geographic position of the computing device 2830.

The example in FIG. 28 may be a hardware configuration, although the components shown may be implemented as software as well. Modifications may be made to add, remove, combine, divide, etc. components of the computing device 2830 as desired. Additionally, the components may be implemented using basic computing devices and components, and the same components (e.g., processor 2831, ROM storage 2832, display 2836, etc.) may be used to implement any of the other computing devices and components described herein. For example, the various components described herein may be implemented using computing devices having components such as a processor executing computer-executable instructions stored on a computer-readable medium, as shown in FIG. 28. Some or all of the entities described herein may be software based, and may co-exist in a common physical platform (e.g., a requesting entity may be a separate software process and program from a dependent entity, both of which may be executed as software on a common computing device).

A computing device may perform a method comprising multiple operations. The computing device may determine a block vector difference (BVD) that may be based on a difference between a block vector (BV) and a block vector predictor (BVP). The computing device may select a probability model that may be based on a first indication of whether a value of a first symbol of the BVD matches a value of a first symbol of a first BVD predictor. The computing device may encode a second indication of whether a value of a second symbol of the BVD matches a value of a second symbol of a second BVD predictor that may be based on the probability model. The first indication may be encoded before the second indication. Selecting the probability model may be further based on a significance of the second symbol of the BVD or the second symbol of the BVD predictor. The significance of the second symbol may be determined based on a position of the second symbol in the BVD. The significance of a second symbol may be determined based on a change in value of the BVD for an incremental change in value of the second symbol of the BVD. Selecting the probability model may be further based on a size of a block that is predicted based on the BVD. Selecting the probability model may be further based on a directional component of the BVD comprising the first and second symbol of the BVD. The directional component of the BVD may be one of a horizontal component or a vertical component. Selecting the probability model further may further comprise selecting the probability model based on a third indication of whether a value of a third symbol of the BVD matches a value of a third symbol of a third BVD predictor. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to decode an indication. A computer-readable medium may store instructions that, when executed, cause performance of the described method, additional operations and/or include the additional elements.

A computing device may perform a method comprising multiple operations. The computing device may select a probability model that may be based on a first indication of whether a value of a first symbol of a block vector difference (BVD) matches a value of a first symbol of a first BVD predictor. The computing device may decode a second indication of whether a value of a second symbol of the BVD matches a value of a second symbol of a second BVD predictor that may be based on the probability model. The computing device may determine a value of the second symbol of the BVD that may be based on an indication and the value of the second symbol of the BVD predictor. The first indication may be decoded before the second indication. Selecting the probability model may be further based on a significance of the second symbol of the BVD. A significance of a second symbol may be determined based on a position of the second symbol in the BVD. A significance of a second symbol may be determined based on a change in value of the BVD for an incremental change in value of the second symbol of the BVD. Selecting the probability model may be further based on a size of a block that may be predicted based on the BVD. Selecting the probability model may be further based on a directional component of the BVD comprising a first and second symbol. A directional component of the BVD may be one of a horizontal component or a vertical component. Selecting the probability model may be further based on a third indication of whether a value of a third symbol of the BVD matches a value of a third symbol of a third BVD predictor. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to encode an indication. A computer-readable medium may store instructions that, when executed, cause performance of the described method, additional operations and/or include the additional elements.

A computing device may perform a method comprising multiple operations. The computing device may decode a first indication of whether a value of a first symbol of a block vector difference (BVD) matches a value of a first symbol of a first BVD predictor. The computing device may determine a significance of a second symbol based on a position of the second symbol. The computing device may select a probability model that may be based on a first indication. The computing device may decode a second indication of whether a value of a second symbol of the BVD matches a value of a second symbol of a second BVD predictor that may be based on the probability model. The computing device may determine a value of the second symbol of the BVD that may be based on the second indication and a value of the second symbol of the BVD predictor. Selecting the probability may be further based on one or more of a significance of the second symbol of the BVD, a size of a block that may be predicted based on the BVD, a directional component of the BVD comprising the first and second symbol of the BVD, and a third indication of whether a value of a third symbol of the BVD matches a value of a third symbol of a third BVD predictor. The significance of the second symbol may be determined based on a position of the second symbol in the BVD. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to encode an indication. A computer-readable medium may store instructions that, when executed, cause performance of the described method, additional operations and/or include the additional elements.

One or more examples herein may be described as a process which may be depicted as a flowchart, a flow diagram, a data flow diagram, a structure diagram, and/or a block diagram. Although a flowchart may describe operations as a sequential process, one or more of the operations may be performed in parallel or concurrently. The order of the operations shown may be re-arranged. A process may be terminated when its operations are completed, but could have additional steps not shown in a figure. A process may correspond to a method, a function, a procedure, a subroutine, a subprogram, etc. If a process corresponds to a function, its termination may correspond to a return of the function to the calling function or the main function.

Operations described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks. Features of the disclosure may be implemented in hardware using, for example, hardware components such as application-specific integrated circuits (ASICs) and gate arrays. Implementation of a hardware state machine to perform the functions described herein will also be apparent to persons skilled in the art.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein. Computer-readable medium may comprise, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

A non-transitory tangible computer readable media may comprise instructions executable by one or more processors configured to cause operations described herein. An article of manufacture may comprise a non-transitory tangible computer readable machine-accessible medium having instructions encoded thereon for enabling programmable hardware to cause a device (e.g., an encoder, a decoder, a transmitter, a receiver, and the like) to allow operations described herein. The device, or one or more devices such as in a system, may include one or more processors, memory, interfaces, and/or the like.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more of the operations described herein may be conditional. For example, one or more operations may be performed if certain criteria are met, such as in computing device, a communication device, an encoder, a decoder, a network, a combination of the above, and/or the like. Example criteria may be based on one or more conditions such as device configurations, traffic load, initial system set up, packet sizes, traffic characteristics, a combination of the above, and/or the like. If the one or more criteria are met, various examples may be used. It may be possible to implement any portion of the examples described herein in any order and based on any condition.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
based on a first indication of whether a value of a first symbol of a block vector difference (BVD) matches a value of a first symbol of a first BVD predictor, selecting a probability model;
decoding, based on the probability model, a second indication of whether a value of a second symbol of the BVD matches a value of a second symbol of a second BVD predictor; and
based on the second indication and a value of the second symbol of the second BVD predictor, determining a value of the second symbol of the BVD.

2. The method of claim 1, wherein the first indication is decoded before the second indication.

3. The method of claim 1, wherein the selecting the probability model is further based on a significance of the second symbol of the BVD.

4. The method of claim 1, further comprising:
determining, based on a position of the second symbol of the BVD, a significance of the second symbol.

5. The method of claim 1, further comprising:
determining, based on a change in a value of the BVD for an incremental change in the value of the second symbol of the BVD, wherein a significance of a second symbol is determined.

6. The method of claim 1, wherein the selecting the probability model further comprises:
selecting the probability model based on a size of a block that is predicted using the BVD.

7. The method of claim 1, wherein the selecting the probability model further comprises:
selecting the probability model based on a directional component, of the BVD, comprising the first symbol of the BVD predictor and the second symbol of the BVD predictor.

8. The method of claim 1, wherein a directional component of the BVD is one of a horizontal component or a vertical component.

9. The method of claim 1, wherein the selecting the probability model further comprises:
selecting the probability model based on a third indication of whether a value of a third symbol of the BVD matches a value of a third symbol of a third BVD predictor.

10. A method comprising:
based on a difference between a block vector (BV) and a block vector predictor (BVP), determining a block vector difference (BVD);
based on a first indication of whether a value of a first symbol of the BVD matches a value of a first symbol of a first BVD predictor, selecting a probability model; and
encoding, based on the probability model, a second indication of whether a value of a second symbol of the BVD matches a value of a second symbol of a second BVD predictor.

11. The method of claim 10, wherein the first indication is encoded before the second indication.

12. The method of claim 10, wherein the selecting the probability model is further based on a significance of either the second symbol of the second BVD predictor or the second symbol of the BVD.

13. The method of claim 10, further comprising:
determining, based on a position of a second symbol in the BVD, a significance of the second symbol of the BVD.

14. The method of claim 10, further comprising:
determining, based on a change in a value of the BVD for an incremental change in a value of a second symbol of the BVD, a significance of the second symbol the BVD.

15. The method of claim 10, wherein the selecting the probability model further comprises: selecting the probability model based on a size of a block that is predicted using the BVD.

16. The method of claim 10, wherein the selecting the probability model further comprises:
selecting the probability model based on a directional component, of the BVD, comprising the first symbol and the second symbol of the BVD.

17. The method of claim 10, wherein a directional component of the BVD is one of a horizontal component or a vertical component.

18. The method of claim 10, wherein the selecting the probability model further comprises:
selecting the probability model based on a third indication of whether a value of a third symbol of the BVD matches a value of a third symbol of a third BVD predictor.

19. A method comprising:
decoding a first indication of whether a value of a first symbol of a block vector difference (BVD) matches a value of a first symbol of a first BVD predictor;
determining, based on a position of a second symbol in the BVD, a significance of the second symbol;
selecting, based on the first indication and the significance of the second symbol in the BVD, a probability model;
based on the probability model, decoding a second indication of whether a value of a second symbol of the BVD matches a value of a second symbol of a second BVD predictor based on the probability model; and
determining, based on the second indication and a value of the second symbol of the BVD predictor, a value of the second symbol of the BVD.

20. The method of claim 19, wherein the selecting the probability is further based on one or more of:
a size of a block that is predicted based on the BVD;
a directional component, of the BVD, comprising the first symbol and the second symbol of the BVD; and
a third indication of whether a value of a third symbol of the BVD matches a value of a third symbol of a third BVD predictor.
